(19) United States
(12) Patent Application Publication
(10) Pub. No.: US 2003/0048927 A1
(43) Pub. Date: Mar. 13, 2003

(54) Grain quality judging sample container, grain quality judger, grain quality judging system, grain image reading device, sample arraying jig for the grain image reading device, sample arraying method, and sample arrayer for the grain image reading device

(76) Inventors: Toshiyuki Sato, Yamagata-shi (JP); Soichi Yamamoto, Tendo-shi (JP); Tsuneyoshi Goto, Tendo-shi (JP); Hiroshi Arai, Tendo-shi (JP)

Correspondence Address: Otto O. Lee, Esq., Intellectual Property Law Group LLP, 12th Floor, 12 South First Street, San Jose, CA, 95051, US

(21) Appl. No.: 10/040,710

(22) Filed: Dec. 28, 2001

(30) Foreign Application Priority Data
Sep. 10, 2001 (JP) 2001-273059
Sep. 19, 2001 (JP) 2001-284994
Sep. 19, 2001 (JP) 2001-284995
Sep. 26, 2001 (JP) 2001-293134

(51) Int. Cl. G06K 9/00

(52) U.S. Cl. 382/110

(57) ABSTRACT

To a sample bed 30 having a transparent bottom face 30A, a cover member 32 is attached in an openable/closable manner by means of a hinge 31. In this cover member 32, there is mounted a plurality of bar-shaped light sources 36 which are made of fluorescent lamps or the like. Between the bar-shaped light sources 36 and the sample bed 30, there is arranged an oblique ray louver 38 which is arranged in parallel with the bottom face of the sample bed 30 for homogenizing the direction of lights emitted by the bar-shaped light sources 36, obliquely so that grains placed on the sample bed 30 may be irradiated with the lights in the inclined direction.

### BACKGROUND OF THE INVENTION

1. Field of the Invention

The present invention relates to a grain quality judging sample container, a grain quality judger (judging device), a grain quality judging system, a grain image reading device, a sample arraying jig for the grain image reading device, a sample arraying method, and a sampler arrayer (arraying device) for the grain image reading device.

2. Description of the Related Art

In Japanese Patent No. 2815633, there is disclosed a rice grain quality judging device for judging the grade of hulled rice, milled rice or unhulled rice by irradiating rice grains being conveyed one by one with a light and by measuring the quantity of the reflected light of each rice grain. However, the quality of each rice grain is judged by irradiating it with the light, and the disclosed device is troubled by a problem that the inspection takes an extremely long time period.

In Examined Published Japanese Utility Model Application No. 7-33151, there is described a rice grain quality judging device for judging the quality of rice grains one by one by putting the rice grains in the individual ones of numerous recesses formed in a sample dish and by irradiating the rice grains with a light, and by activating a scanner to fetch the image of the grains on the basis of the reflected light or transmitted light from the rice grains.

In the above rice grain quality judging device, however, the quality of the rice grain is judged from the image which is obtained from the reflected light or the transmitted light of the rice grains. In the case using the reflected light, therefore, it is possible to discriminate broken rice, unhulled rice, dead rice, browned rice, blue immature rice or colored rice damaged by insect pest, but it is difficult to discriminate cracked rice kernels highly precisely. In the case using the transmitted light, it is possible to discriminate the cracked rice kernels, but it is difficult to discriminate the remaining defective rice grains. In either case, there is still unsolved a problem that the quality of the rice grains cannot be judged highly precisely.

Especially the cracked rice kernels are so defective as have cracks or broken planes therein. Therefore, the judgment of the cracked rice kernels is far more difficult than that of the defective rice grains such as the broken rice grains or the colored rice grains which are abnormal in their contours or colors. Even if the cracked rice kernels could be discriminated from the transmitted optical image, therefore, their detecting precision is still low, and it is an important future target to enhance the detecting precision of the internal cracks anyhow.

In view of such background, we have developed a grain image reading device capable of solving those problems and are considering a development of a grain image reading device having a high additional value by making further improvements from various viewpoints. One being considered is whether or not grains or samples are to be quickly arrayed at a predetermined interval in a predetermined direction by a simple method when they are placed on a sample bed made of a transparent glass plate. This is because the samples can be irradiated for a more homogeneous inspection result with the light under identical conditions, if they could be placed on the sample bed at the interval in the direction, than the samples placed randomly on the sample bed. If the trouble of placing the samples in a proper density without any overlap on the sample bed could be omitted, moreover, there is obtained a merit to shorten the working time period.

### SUMMARY OF THE INVENTION

The invention has been made to solve the above-specified problems and has an object to provide a grain quality judging sample container, a grain quality judger and a grain quality judging system, which can judge the quality of grains such as rice grains highly precisely.

Another object of the invention is to provide a grain image reading device capable of improving the grain quality judging precision and a grain quality judging device using the reading device.

Still another object of the invention is to provide a grain image reading device which is enabled to improve the grain quality judging precision by enhancing the precision for judging cracked rice kernels.

A further object is to provide a sample arraying jig for a grain image reading device, which can place sample grains simply and quickly in an arrayed state on a sample bed, a sample arraying method using the jig, and a sample arrayer for the grain image reading device.

According to an aspect of the invention, there is provided a grain quality judging sample container comprising: a sample bed having a transparent bottom face for placing grains thereon; a light source disposed above the sample bed for emitting a light to illuminate the samples placed on the sample bed; and an oblique ray louver for homogenizing the light emitted from the light source, in an oblique direction so that the grains placed two-dimensionally on the sample bed may be irradiated with the light in the oblique direction.

According to this invention, when the sample placed on the sample bed is to be illuminated, the direction of the light emitted from the light source is homogenized in an oblique direction by an oblique ray louver so that the grains placed two-dimensionally on the sample bed are irradiated with the light in the inclined direction. Here, the grains need not be regularly placed on the sample bed but may be randomly placed. By thus irradiating the grains with the light in the inclined direction, a shadow is easily formed, if the grains have broken planes, in the grains. This shadow can be observed by irradiating the transparent bottom face with the light and by using the two kinds of lights: the transmitted light emitted from the light source and transmitted through the bottom face of the sample bed; and the reflected light emitted from the bottom face side and reflected by the grains, so that the grain quality can be judged highly precisely.

According to another aspect of the invention, there is provided a grain quality judging sample container comprising: a sample bed having a transparent bottom face for placing grains thereon; and a multiplicity of light emitting elements arrayed two-dimensionally to have a light emitting direction inclined with respect to the sample placing face of the sample bed, so that the grains placed two-dimensionally on the sample bed may be irradiated with the light in the oblique direction.

By using not the oblique ray louver but the numerous light emitting elements arrayed two-dimensionally with a light emitting direction inclined with respect to the sample placing face of the sample bed, according to this aspect of the invention, the grains placed on the sample bed are irradiated with the light in the inclined direction. The oblique ray louver is not used so that the structure can be simplified.

According to still another aspect of this invention, there is provided a grain quality judging sample container comprising: a sample bed having a transparent bottom face for placing grains thereon; a light emitting element array including a multiplicity of light emitting elements arrayed one-dimensionally to have a light emitting direction inclined with respect to the sample placing face of the sample bed, so that the grains placed on the sample bed may be irradiated with the light in the oblique direction; and moving means for moving at least one of the sample bed and the light emitting element array in a direction to intersect the array direction of the light emitting elements.

According to this aspect of the invention, at least one of the sample bed and the light emitting element array having the numerous light emitting elements arrayed one-dimensionally is moved for the scanning so that the grains placed on the sample bed may be irradiated with the light in the inclined direction.

According to this aspect of the invention, there is used the light emitting element array having the light emitting elements arrayed one-dimensionally so that the number of light emitting elements can be made smaller than that of the foregoing aspect of the invention.

The irradiation direction of the light of the foregoing individual aspects of the invention is within a range of 30 to 60 degree, preferably 30 degree with respect to the placing face of the sample bed.

According to a further aspect of the invention, there is provided a grain quality judger comprising: a grain quality judging sample container according to any of the aspects of the invention; a scanner for reading images of the grains from a bottom face side of the grain quality judging sample container; and judging means for judging quality of the grains on the basis of the images of the grains read by the scanner.

According to this grain quality judger, the image of the grains is read with the two kinds of lights, i.e., the reflected light and the transmitted light: the light from the light source disposed in the scanner; and the light from the light source disposed in the gain quality judging sample container so that the grain quality can be judged highly precisely.

In case an image is to be input to the grain quality judger, it is effective that both the information on a grain inside and the information on a grain surface are extracted by inter-image operations of a reflected optical image, as read by turning OFF the light in the inclined direction, and an image, as read by turning ON the light in the inclined direction and are input to the judging means. Thus, it is possible to discriminate the partially colored grains such as the cracked rice kernels or the white belly rice.

A grain quality judging system terminal can be constructed by providing a grain quality judger thus constructed, with functions: to accumulate or tally up images and judgment results; to compress data; to encrypt data; to record data in auxiliary storage device media; to print data; to distribute data through a network; and to protect data by a password, or with a plurality of functions selected from the former functions.

A grain quality judging system is constructed by connecting a plurality of grain quality judging system terminals, and administration means for displaying the image read by the scanner and the judgment result of the judging means, with a network.

This system is enabled, by comparing the image displayed in the administration means and read by the scanner and the judgment result of the judging means, to judge whether or not the grain quality judger acts normally and whether or not the judgment result of the grain quality judger is erroneous, thereby to administer the actions of the grain quality judger efficiently on the basis of the judgment result.

According to a further aspect of the invention, there is provided a grain image reading device comprising: a scanner body including: a sample bed disposed at an image reading position and having a bottom portion made of a transparent material for placing grains two-dimensionally thereon; and scan means having an optical irradiation portion made movable along the bottom portion of the sample bed for irradiating the grains with a light, and a light receiving portion for receiving the reflected light reflected by the grains; and a cover member made openable/closable with respect to the sample bed of the scanner body and including oblique ray means for irradiating the grains obliquely when closed, wherein an image of the grains is read by using two kinds of lights: a transmitted light emitted from the oblique ray means, transmitted through the grains and received by the light receiving portion of the scan means; and a reflected light emitted from the optical irradiation portion, reflected by the grains and received by the light receiving portion of the scan means.

According this aspect of the invention, the sample bed having the bottom portion made of a transparent material is arranged at the image reading position of the scanner body of the grain image reading device. The cover member is closed after the grains are placed two-dimensionally on the sample bed. In this state, the image of the grains is read.

Here, the invention is enabled to read the image of the grains by using two kinds of lights, i.e., the reflected light and the transmitted light. By moving the scan means along the bottom portion of the sample bed while irradiating the grains with the light from the optical irradiation portion, the reflected light reflected by the grains is received by the light receiving portion. Therefore, the reflected optical image of the grains can be obtained to read the states of the grain surface such as the contours or colors of the grains to find out the abnormal surface grains (e.g., the broken rice, the unhulled rice, the dead rice, the browned rice, the blue immature rice, the colored rice damaged by the insert pest) highly precisely.

On the other hand, the cover member is provided with the oblique ray means so that the grains can be irradiated with the light in the oblique direction by using the oblique ray means. The light transmitted through the grains is received by the light receiving portion of the scanner body so that the transmitted optical image of the grains is obtained. If the grains are obliquely irradiated with the light as in the invention, their insides are easily shaded with shadows if cracked or planarly broken. By reading the shadows, therefore, the state of the grain insides such as the cracks or the broken planes can be read to find out the internally abnormal grains (e.g., the cracked rice kernels) highly precisely.

By using the grain image reading device according to the invention, therefore, both the abnormal surface grains and the internally abnormal grains can be detected highly precisely to improve the quality judgment precision of the grains.

In addition, the grain image reading device according to the invention is enabled to reduce the size and weight of the side of the cover member by arranging the sample bed on the side of the scanner body. In other words, the structure having the sample bed on the cover member would rather be the “box member” than the “cover member”. By arranging the sample bed on the side of the scanner body as in the invention, however, it is possible to reduce the size and weight of the “cover member”. As a result, the cover member could be openably attached to the sample bed of the scanner body, or the two members could also be integrated.

According to a further aspect of the invention, there is provided a grain image reading device comprising: the grain image reading means; and judgment means connected with the grain image reading means for judging the quality of the grains on the basis of the image information sent from the grain image reading means.

According to this aspect of the invention, the image of the grains is read by the grain image reading means. This image information is transmitted to the judgment means connected with the grain image reading means, by which the quality of the grains is judged on the basis of the input image information.

The grain quality judging device according to the invention has an excellent effect to improve the quality judging precision of the grains.

According to a further aspect of the invention, there is provided a grain image reading device comprising: a scanner body including: a sample bed disposed at an image reading position and having a bottom portion made of a transparent material for placing grains two-dimensionally thereon; and scan means having an optical irradiation portion made movable along the bottom portion of the sample bed for irradiating the grains with a light, and a light receiving portion for receiving the reflected light reflected by the grains; and a cover member made openable/closable with respect to the sample bed of the scanner body and including a light source for irradiating the grains obliquely when closed, wherein the optical irradiation portion of the scan means has an optical axis direction set to have a predetermined angle of inclination with respect to the sample placing face of the sample bed, and wherein the light source is so fixed on the end side of the sample placing face of the sample bed in the cover member as to have an optical axis direction set at a predetermined angle of inclination with respect to the sample placing face of the sample bed.

According to this aspect of the invention, the grains are placed two-dimensionally on the upper face of the sample bed disposed at the image reading position of the scanner body, and the cover member is then closed. In this state, the image of the grains is read.

The scanner body is provided with the scan means capable of moving along the bottom portion of the sample bed so that the light emitted from the optical irradiation portion to the grains and reflected by the grains is received by the light receiving portion by turning ON the optical irradiation portion while moving the scan means. Therefore, the reflected optical image of the grains can be obtained to read the state of the grain surfaces such as the contours or colors of the grains thereby to find out the abnormal surface grains ((e.g., the broken rice, the unhulled rice, the dead rice, the browned rice, the blue immature rice, the colored rice damaged by the insert pest) highly precisely.

Moreover, the cover member is provided with the light source so that the light receiving portion of the scan means receives the light which is emitted from the light source by turning the light source and transmitted through the grains. Therefore, the transmitted optical image of the grains can be obtained so that the state of the grain inside such as whether or not the grains have internally cracking planes can be read to find out the internally abnormal grains (e.g., the cracked rice kernels.

Here in the invention, the optical axis direction of the light source disposed on the side of the cover member is set at a predetermined angle of inclination with respect to the sample placing face of the sample bed so that the light emitted from the light source is obliquely incident on the internally cracking planes of the grains and is randomly reflected on the internally cracking planes. Here in the invention, the light source is disposed on the end side of the sample placing face of the sample bed in the cover member so that all the grains placed on the upper face of the sample bed can be obliquely irradiated with the light. Thus, the quantity of light to be received by the light receiving portion is increased by the intentionally caused random reflections so that the internally cracking planes of the grains becomes different in the lightness and are reflected as the shadows. As a result, the internally cracking planes are very clearly reflected in an image.

In the invention, on the other hand, the optical axis direction of the optical irradiation portion of the scan means is also set at a predetermined angle of inclination with respect to the sample placing face of the sample bed, so that the grains are obliquely irradiated with the light emitted from the optical irradiation portion. Moreover, a portion is reflected on the grain surfaces, but the remaining portion is introduced into the grain insides and is randomly reflected on the internally cracking planes of the grains. Therefore, the quantity of the light to be received by the light receiving portion is increased, which contributes a clear imaging of the internally cracking planes of the grains.

Thus according to the invention, the detection precision of the internally cracking planes of the grains can be enhanced from both the viewpoint of the optical irradiation portion of the scan means and the view point of the light source on the side of the cover member. As a result, it is possible to enhance the judgment precision of the cracked rice kernels and accordingly the quality judgment precision of the grains.

According to a further aspect of the invention, there is provided a sample arraying jig for a grain image reading device having a scanner body including: a sample bed disposed at an image reading position and having a bottom portion made of a transparent material for placing grains two-dimensionally thereon; and scan means having an optical irradiation portion made movable along the bottom portion of the sample bed for irradiating the grains with a light, and a light receiving portion for receiving the reflected light reflected by the grains, comprising: a sample arraying jig body formed into such a tray shape as can be placed on the upper face of the bottom portion of the sample bed, and including a bottom wall portion having such a multiplicity of holes at a predetermined interval as has a size to admit one grain, as formed generally into a grain shape and as has a longer axis direction in a predetermined direction; and a moving member formed to such a size as can slide on the upper face of the bottom wall portion of the sample arraying jig body and as can be placed on the upper face of the bottom wall portion, and having a multiplicity of second holes having the same shape and pattern as those of the multiple first holes.

According to this aspect of the invention, the moving member is placed at first on the upper face of the bottom wall portion of the sample arraying jig body. This moving member is so formed as to slide with respect to the upper face of the bottom wall portion of the sample arraying jig body so that it can slide in the sample arraying jig body. In the sample arraying jig body, moreover, there are formed the numerous first holes which are formed generally into the grain shape and have their longer axis directions directed in a predetermined direction. In the moving member, there are correspondingly formed the numerous second holes which have the same shape and pattern as those of the first holes. By sliding the moving member slightly with respect to the sample arraying jig body, therefore, there can be established a state in which the second holes are offset from the first holes. With this offset of the second holes from the first holes, the portions without the first holes of the bottom wall portion of the sample arraying jig body are positioned below the second holes. In short, the second holes have bottom faces formed. In this state, when the grains or samples are put into the sample arraying jig body and when this sample arraying jig body and the moving member are shaken or when the grains put in are raked with the finger tips or a spatula, the grains go one by one into the second holes of the moving member. After this, the excessive grains are removed from the sample arraying jig body.

In this state, the sample arraying jig body and the moving member are then placed on the upper face of the bottom wall portion of the sample bed, and the moving member is slightly slid with respect to the bottom wall portion of the sample arraying jig body. Then, the second holes are overlaid on the first holes. As a result, the second holes and the first holes are caused to communicate with each other so that the upper face of the bottom portion of the sample bed becomes the bottom faces of the first holes. Then, the grains having entered the second holes fall down into the first holes and are placed on the upper face of the sample bed. After this, the sample arraying jig body and the moving member are lifted and removed from the sample bed. In the state after to this removal, the numerous grains have their longer axis directions in the predetermined direction and are arrayed at the predetermined interval. When the grains or samples are thus placed on the upper face of the sample bed by using the sample arraying jig for the grain image reading device according to the invention, the grains can be placed simply and quickly in the arrayed state.

When the samples are thus arrayed and arranged on the upper face of the sample bed, the image of the grains is read by using the scanner body. Specifically, the reflected light reflected on the grains is received by the light receiving portion by moving the scan means along the bottom portion of the sample bed while irradiating the grains with the light from the optical irradiation portion of the scan means. As a result, the reflected optical image of the grains can be read.

According to a further aspect of the invention, there is provided a sample arraying method using a sample arraying jig for a grain image reading device, comprising: a first step of placing the moving member on the upper face of the bottom wall portion of the sample arraying jig body and holding the two in a state with the second holes being offset from the first holes; a second step of putting grains as samples in the sample arraying jig body in the state and introducing the grains one by one into the second holes; a third step of placing the sample arraying jig body and the moving member in the state on the upper face of the bottom portion of the sample bed; a fourth step of sliding the moving member with respect to the bottom wall portion of the sample arraying jig body and overlaying the second holes on the first holes; and a fifth step of lifting and removing the sample arraying jig body and the moving member in the state from the sample bed.

According to this aspect of the invention, the grains or samples can be placed in the arrayed state on the upper face of the sample bed of the scanner body in the following manners.

At the first step, the moving member is placed on the upper face of the bottom wall portion of the sample arraying jig body. Next, the second holes of the moving member and the first holes of the sample arraying jig body are so held that the former are offset from the latter. Therefore, the portions without the first holes of the sample arraying jig body provide the bottom face of the second holes. Next, at the second step, the grains or samples are put into the sample arraying jig body. Next, the grains are introduced one by one into the second holes while the sample arraying jig body and the moving member being shaken or while the grains put in being raked with the finger tips or the knife. Next, at the third step, the sample arraying jig body and the moving member are placed on the upper surface of the bottom portion of the sample bed. Next, at the fourth step, the moving member is slit with respect to the bottom wall portion of the sample arraying jig to overlay the second holes on the first holes. Therefore, the second holes and the first holes are caused to communicate with each other so that the upper face of the bottom portion of the sample bed provides the bottom faces of the first holes. Then, the grains in the second holes fall down into the first holes and are placed on the upper face of the sample bed. Next, at the fifth step, the sample arraying jig and the moving member are lifted and removed from the sample bed. After this removal, the numerous grains are arrayed at the predetermined interval with their longer axis directions being directed in the predetermined direction.

With this construction, there can be attained an excellent effect that the grains or samples can be placed simply and quickly in the arrayed state over the sample bed.

According to a further aspect of the invention, there is provided a sample arrayer for a grain image reading device having a scanner body including: a sample bed disposed at an image reading position and having a bottom portion made of a transparent material for placing grains two-dimensionally thereon; and scan means having an optical irradiation portion made movable along the bottom portion of the sample bed for irradiating the grains with a light, and a light receiving portion for receiving the reflected light reflected by the grains, comprising: a sample arraying plate formed into a tray shape, and including a bottom wall portion having such a multiplicity of holes at a predetermined interval as has a size to admit one grain, as formed generally into a grain shape and as has a longer axis direction in a predetermined direction; and a sample arrayer body including: a support member formed generally into such a frame shape as can fit the bottom wall portion of the sample arraying plate; and a transparent plate arranged on the bottom portion of the support member and placed on the upper face of the bottom portion of the sample bed for placing the bottom wall portion of the sample arraying plate.

According to this aspect of the invention, the bottom wall portion of the sample arraying plate is placed at first on the transparent plate such that the sample arraying plate is fitted in the support member of the sample arrayer body. Therefore, the bottom face of the numerous holes formed in the sample arraying plate is closed with the transparent plate. In short, the bottom face is formed on the holes. In this state, the grains are then put onto the sample arraying plate, and the sample arraying plate is shaken vertically or horizontally, or the grains put in are raked with the finger tips or the spatula. Therefore, the grains introduce one by one into the holes. Next, the sample arrayer body is placed on the upper surface of the bottom portion of the sample bed while the arraying plate being mounted in the sample arrayer body. Next, the sample arraying plate is removed from the sample arrayer body. In the state after this removal, the numerous grains are so placed on the upper face of the transparent plate that they are arrayed at the predetermined interval with their longer axis being directed in the predetermined direction.

Here, the grain image is read by using the scanner body when the samples are placed in the arrayed state on the upper face of the transparent plate of the sample arrayer body. By moving the scan means along the bottom portion of the sample bed while irradiating the grains with the light from the optical irradiation portion of the scan means, more specifically, the reflected light reflected by the grains is received by the light receiving portion. Therefore, it is possible to read the reflected optical image of the grains. At this time, the bottom portion of the sample bed is made of the transparent material, and the transparent plate of the sample arrayer body is also transparent. With the sample arrayer body being placed on the upper face of the bottom portion of the sample bed, therefore, the grain image can be read simply and quickly.

### BRIEF DESCRIPTION OF THE DRAWINGS

FIG. 1 is a schematic diagram of a grain quality judging system of an embodiment of the invention;

FIG. 2 is a schematic diagram of a first embodiment of a grain quality judger;

FIG. 3 is a schematic diagram showing a first embodiment of a grain quality judging sample container with its cover member being opened;

FIG. 4A is a schematic diagram showing the first embodiment of the grain quality judging sample container with its cover member being closed, and FIG. 4B is a side elevation of FIG. 4A;

FIG. 5 is a diagram illustrating a good grain region in a relation between R and B of image information;

FIG. 6 is a diagram illustrating a good grain region in a relation between G and B of the image information;

FIG. 7 is a diagram illustrating a good grain region in a relation between R and G of the image information;

FIG. 8A is a schematic diagram showing a second embodiment of the grain quality judging sample container with its cover member being closed, and FIG. 8B is a side elevation of FIG. 8A;

FIG. 9A is a schematic diagram showing a third embodiment of the grain quality judging sample container with its cover member being closed, and FIG. 9B is a side elevation of FIG. 9A;

FIG. 10A is a schematic diagram showing a modification of the third embodiment of the grain quality judging sample container with its cover member being closed, and FIG. 10B is a side elevation of FIG. 10A;

FIG. 11A is a schematic diagram showing a fourth embodiment of the grain quality judging sample container with its cover member being closed, and FIG. 11B is a side elevation of FIG. 11A;

FIG. 12 is a sectional view showing the entire construction of a grain image reading device according to a fifth embodiment with its cover member being opened;

FIG. 13A is a sectional view showing the entire construction of the grain image reading device shown in FIG. 12 with its cover member being closed, and FIG. 13B is a side elevation of the same;

FIG. 14A is a sectional view corresponding to FIG. 13A but shows a sixth embodiment (of a surface light source type) of the grain image reading device, and FIG. 14B is a side elevation;

FIG. 15A is a sectional view corresponding to FIG. 13A but shows a seventh embodiment (of a two-dimensional light emitting diode type) of the grain image reading device, and FIG. 15B is a side elevation;

FIG. 16A is a sectional view corresponding to FIG. 13A but shows an eighth embodiment (i.e., another example of the two-dimensional light emitting diode type) of the grain image reading device, and FIG. 16B is a side elevation;

FIG. 17A is a sectional view corresponding to FIG. 13A but shows a ninth embodiment (of a one-dimensional light emitting diode type) of the grain image reading device, and FIG. 17B is a side elevation;

FIG. 18A is a sectional view showing the entire construction of the grain image reading device according to a tenth embodiment with its cover member being closed, and FIG. 18B is a side elevation of the same;

FIG. 19 is a schematic diagram illustrating a concept constituting an essential portion of the present embodiment;

FIG. 20 is a schematic diagram showing an image at the time when a cracked rice kernel being observed using the grain image reading device according to the present embodiment;

FIG. 21 is a schematic diagram corresponding to FIG. 19 but shows an eleventh embodiment which is constructed such that a light to be used can be arbitrarily selected in case both a light source on the cover member side and an optical irradiation portion of a scanning unit are inclined with respect to a sample bed;

FIG. 22 is a perspective view showing the state in which grains are placed on a sample bed of a grain image reading device according to any of the fifth to ninth embodiments;

FIG. 23 is a perspective view showing a sample arraying jig according to a twelfth embodiment;

FIG. 24 is a top plan view showing a first hole formed in the body of the sample arraying jig, as shown in FIG. 23, (and a second hole formed in a moving member), in an enlarged scale;

FIG. 25 is a longitudinal section showing the state in which the moving member is mounted in the sample arraying jig body;

FIG. 26A is an enlarged sectional view of an essential portion and shows the state of grains at the time when the second holes of the moving member are displaced with respect to the first holes of the sample arraying jig body, and FIG. 26B is an enlarged sectional view of an essential portion and shows the state of grains at the time when the second holes are registered with the first holes;

FIG. 27 is a perspective view showing a sample arrayer according to a thirteenth embodiment;

FIG. 28 is a longitudinal section of the sample arrayer shown in FIG. 27; and

FIG. 29 is a longitudinal section corresponding to FIG. 28 but shows a comparison for explaining the effects of the sample arrayer according to the thirteenth embodiment.

### DETAILED DESCRIPTION OF THE PREFERRED EMBODIMENTS

The embodiments of the invention will be described in detail with reference to the accompanying drawings. The first embodiment relates to a grain quality judging system which is constructed by combining the embodiments of a grain quality judging sample container and a grain quality judger.

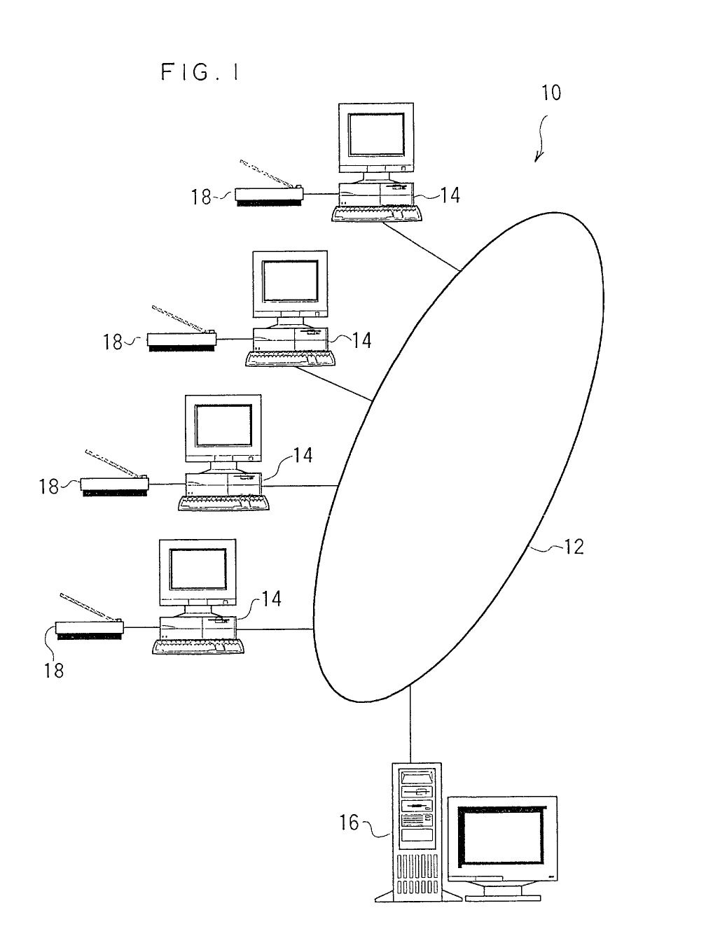

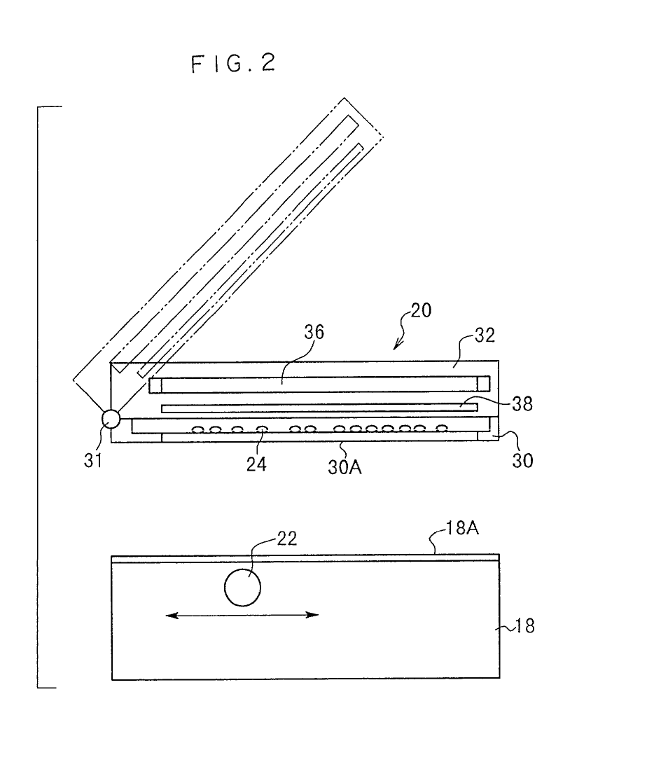

As shown in FIG. 1, a grain quality judging system 10 of the present embodiment is constructed to include: a plurality of client computers 14 connected with a network 12 such as LAN; an administrative server computer 16; and a grain quality judging sample container 20 (as referred to FIG. 2). With each client computer 14, there is connected a color scanner 18 for decomposing the images of grains such as rice grains in the grain quality judging sample container 20, as placed on the glass face of the body, into three RGB colors (i.e., red, green and blue colors), to read and input them to the client computer 14. This color scanner 18 is exemplified by a commercially available color scanner. In this color scanner 18, as shown in FIG. 2, there is reciprocatively mounted a scanning unit 22 which includes: a light source for illuminating grains 24 such as rice grains in the grain quality judging sample container 20 placed on the face of a glass 18A of the scanner body; and color CCDs for reading the images of grains illuminated by the light source, by decomposing them into the three RGB colors. A two-dimensional scan is done by moving the scanning unit 22 so that the images of the grains 24 in the grain quality judging sample container 20 placed on the glass face of the scanner body are read.

The client computer 14 is provided with functions: to sum the images and judgment results; to compress the data; to encrypt the data; to record the data in auxiliary storage device media; to print the data; to distribute the data via the network; and protect the data by passwords, and is constructed to function as the grain quality judging system terminal.

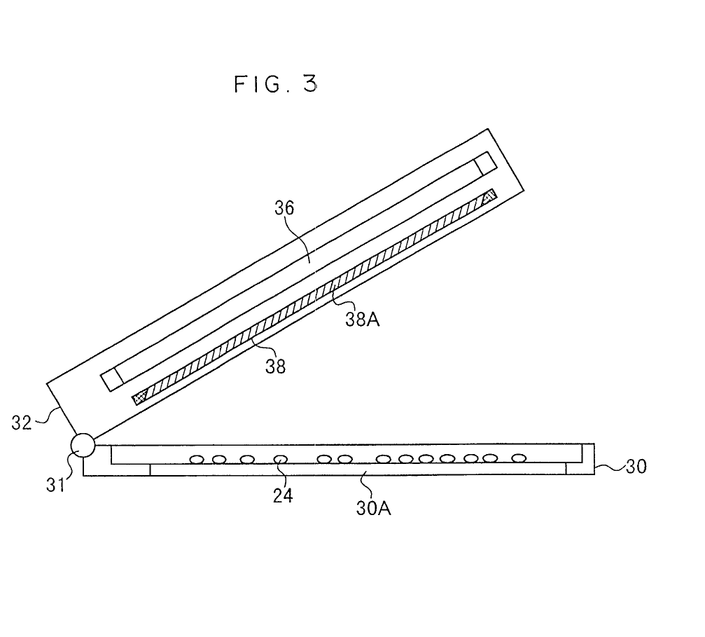

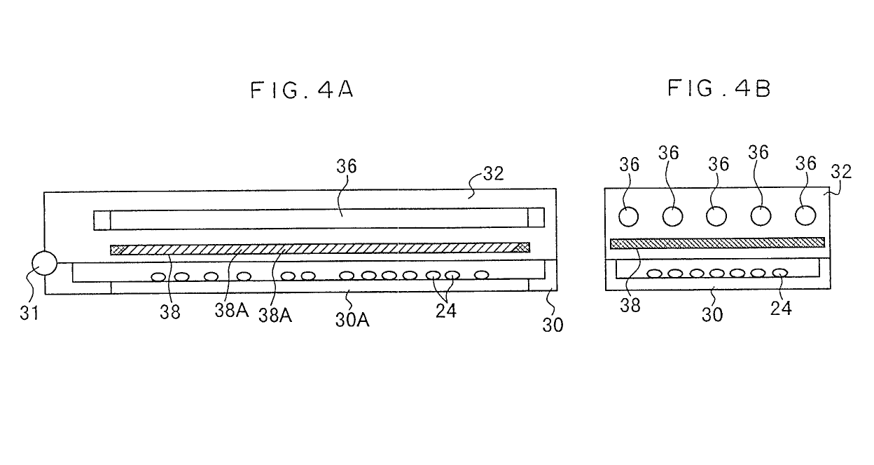

The grain quality judging sample container 20 is provided, as also shown in FIG. 3 and FIGS. 4A and 4B, with a box-shaped sample bed 30 which has an upper face opened and a bottom face 30A made transparent of a transparent plate member such as a transparent glass plate or a transparent film. Here, not only the bottom face but also the entirety of the sample bed 30 can be made transparent of the transparent plate member of the transparent glass plate or the transparent film. The inner side of the bottom face of the sample bed 30 is flattened to place randomly a plurality of grains (or samples), preferably a multiplicity of grains, to be judged for their qualities. In this embodiment, the bottom face of the sample bed 30 is made flat but not recessed for receiving the rice grains one by one so that the grains are placed at random. A cover member 32 is openably attached to the sample bed 30 by a hinge 31.

The inner side of the bottom face of the cover member 32 is formed to reflect a light, and a plurality of bar-shaped light sources 36 such as fluorescent lamps are attached in parallel to the inside of the cover member 32.

On the optical irradiation side of the bar-shaped light sources 36, i.e., between the bar-shaped light sources 36 and the sample bed 30, there is so arranged in parallel with the bottom face of the sample bed 30 an oblique ray louver 38 for homogenizing the directions of rays irradiated from the bar-shaped light sources, in the oblique direction so that the grains placed on the sample bed 30 may be obliquely irradiated. This oblique ray louver 38 is constructed of sheet members of plastics, in which numerous optical paths 38A for transmitting the rays obliquely are formed in parallel. The angle of inclination of the rays with respect to the bottom face of the sample bed 30, i.e., the angle of the optical paths 38A with respect to the bottom face of the sample bed 30 can be set within a range of 30 to 60 degrees, of which the angle of 30 degrees is appropriate. The oblique ray louver 38 to be used can be exemplified by the “Light Control Panel” (as known under the trade name of Edmond Scientific Japan Co., Ltd.).

The grain quality judging sample container 20 thus constructed is combined, as shown in FIG. 2, with the scanner 18 connected with the client computer 14 functioning as a judging unit and is placed on the glass face of the scanner 18 so that it constructs the grain quality judger together with the scanner 18 and the client computer 14.

Here will be described the actions of the present embodiment. First of all, teaching is conducted by charging the grain quality judging sample container with the grains having a known grade (i.e., the grains of a nondefective grade) so that the judgment result may be nondefective. When the grain quality and the judgment result are uncoincident, teaching is conducted to make the grain quality and the judgment result coincident by adjusting the minimum Rmin and the maximum Rmax of the R signal and the gradients a1, a2, b1 and b2 of a judgment table, in which two colors shown in FIGS. 5 to 7 are combined, for judging a predetermined grain quality. When the grains of another grade are to be judged, the grains classified into the grade to be judged may be charged into the grain quality judging sample container, and the teaching may be made to ensure that the judgment result is nondefective. By these teachings, the grains of a target grade can be judged as nondefective.

Next, the cover member 32 of the grain quality judging sample container 20 is opened, and the grains (or samples) 24 to be judged are charged. After this, the cover member 32 is closed, and the grain quality judging sample container 20 is placed on the glass face of the scanner 18. When this bar-shaped light source 36 is turned ON, it emits the light. This emitted light is obliquely homogenized in its direction by the oblique ray louver 38 so that the grains 24 or the rice grains placed on the sample bed 30 are irradiated with the ray in the inclined direction within a range of 30 to 60 degrees with respect to the placing face of the sample bed 30.

When the scanning unit 22 of the scanner 18 is driven and moved in this state, the grains 24 are illuminated from the bottom face side by the light source of the scanning unit 22, and the transmitted light by the illumination light from the bar-shaped light source 36 and the reflected light by the illumination light from the light source of the scanning unit 22 are input to the color CCDs so that the images of the reflected light and the transmitted light are read by the color CCDs.

At this time, the grains 24 are irradiated with the light in the oblique direction. If broken faces are present in the grains, therefore, the irradiating light is shaded by the broken faces to form shadows. These shadows are detected by the scanner, and it is decided by the grain quality judging treatment whether or not the individual color signals are in regions within predetermined ranges. Then, it is possible to judge the quality of the grains highly precisely.

The grain quality judging treatment is made to extract the information on the inside and surface of a grain by operating the relations between the reflected image, which is read with the illumination of only the scanning unit 22 of the scanner 18 by turning OFF the bar-shaped light source 36 to shut the light of the inclined direction, and the illuminated image which is read with the transmitted oblique light by turning ON the bar-shaped light source 36 to admit the light in the inclined direction. This judgment is effective because it is possible to discriminate partially colored grains such as white belly grains from cracked grains. Here, the information (or the image signals) on the grain inside is obtained by subtracting the reflected image from the obliquely transmitted light illuminated image, and the information (or the image signals) on the grain surface is obtained from the reflected image.

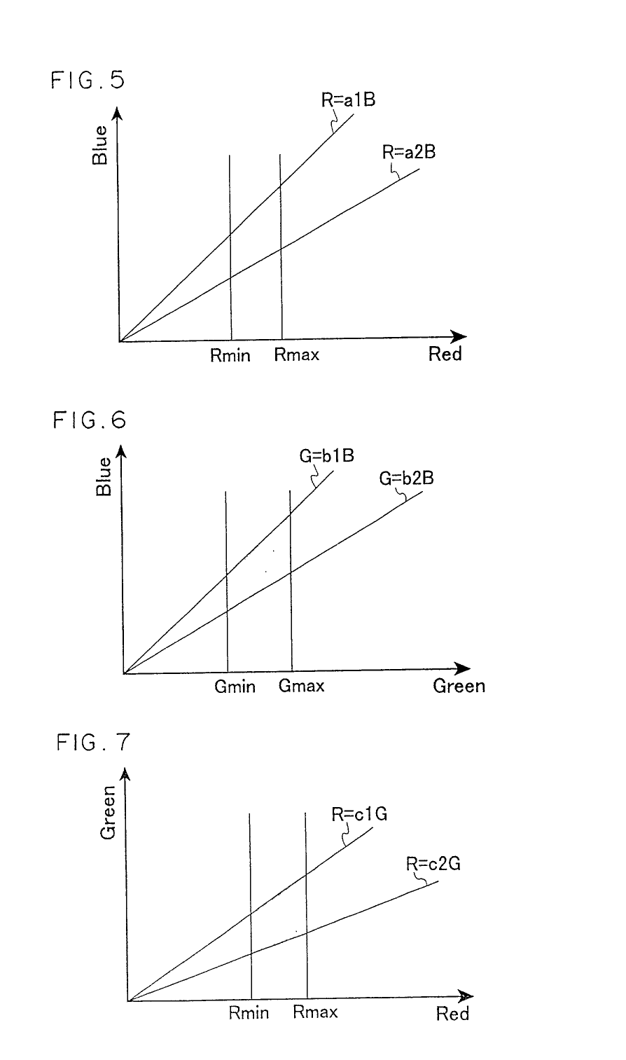

Here will be described the grain quality judging routine. Each client computer 14 fetches the image signals of the grains from the scanner 18 and decides, for the individual image signals of the three RGB colors of the individual pixels, whether or not the conditions of a1B>R>a2B and Rmin<R<Rmax are satisfied, as illustrated in FIG. 5, and whether or not b1B>G>b2B and Gmin<G<Gmax are satisfied, as illustrated in FIG. 6, and whether or not c1G>R>c2G and Rmin <R<Rmax are satisfied, as illustrated in FIG. 7. Here: Rmin designates the minimum of the image signals of the R color; Rmax designates the maximum of the image signals of the R color; Gmin designates the minimum of the image signals of the G color; Gmax designates the maximum of the image signals of the G color; and a1, a2, b1, b2, c1 and c2 designate constants indicating the gradients of straight lines illustrated in FIGS. 5 to 7.

In case both the pieces of information on the grain inside and surface are to be extracted and judged, whether or not the above-specified conditions are satisfied may be decided on the individual pieces of information (or the image signals) on the grain inside and surface.

If these conditions on the R/G/B are satisfied, moreover, it is judged that grains 128 are nondefective on the colors. If not, it is judged that the grains 128 are defective (i.e., dead, brown-colored, blue immature, colored by insect pest or unhulled) on the colors. For these nondefectives, however, the broken rice is judged by the area ratio (i.e., the larger or smaller number of pixels) (although the unhulled rice is also basically judged by the area ratio), and the cracked rice kernel is judged by reading the shadow (i.e., the abrupt change in lightness), as formed in the rice inside, by irradiating it with the oblique ray, as has been described hereinbefore. Thus, it is possible to grade the grains 128.

Moreover, the image fetched by the scanner and the judgment result of the client computer 14 are periodically transmitted from the client computer 14 to the server computer 16 so that they are displayed on the screen of the server computer 16. By visually comparing the image fetched with the scanner 18 by the skilled operator and the judgment result of the client computer 14, therefore, it is possible to check whether or not the computers of the grain quality judger are normally working, and whether or not the judgment result disperses among the individual grain quality judgers, thereby to make unified administrations.

There has been described the embodiment in which the grain quality judger is constructed by using the computers connected with the network. However, the invention is not limited thereto but may be embodied by a grain quality judger which comprises a stand-alone type computer that functions as a judging unit and is not connected with the network.

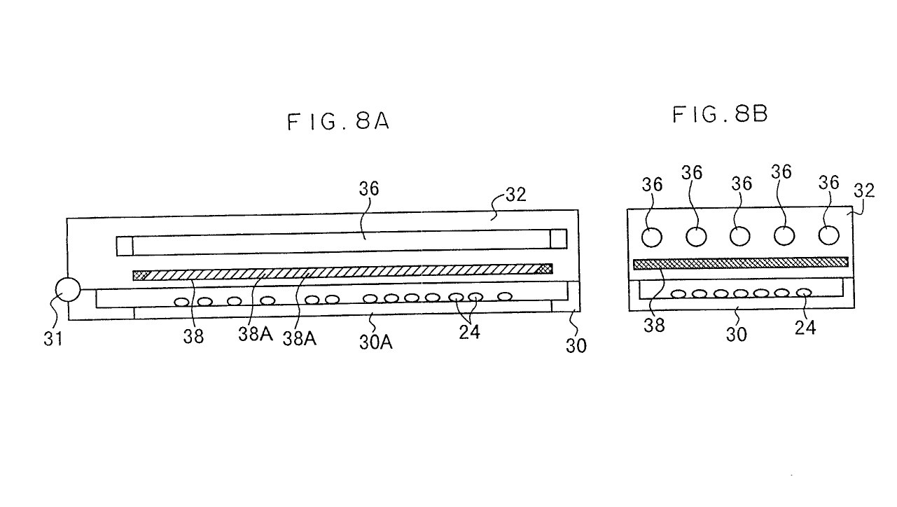

Here will be described another embodiment of the grain quality judging sample container which can be used in the grain quality judger and the grain quality judging system thus far described. FIGS. 8A and 8B show a second embodiment of the grain quality judging sample container, in which a surface light source 40 is used in place of the bar-shaped light source of FIGS. 4A and 4B. This surface light source 40 has, as shown in FIG. 8B, a rectangular diffusing plate 40A arranged in parallel with the oblique ray louver, and a pair of bar-shaped light sources 40B mounted on the opposite sides of the diffusing plate 40A.

When the bar-shaped light sources 40B are lit, the rays propagate in the diffusing plate 40A so that they are emitted as diffused lights from the upper and lower faces of the diffusing plate 40A. On the other hand, the diffused light, as emitted from the surface light source 40, is homogenized in the oblique direction by the oblique ray louver 38 to irradiate the grains 24, as placed on the sample bed, in the obliquely direction.

In this embodiment, the surface light source is used to irradiate the oblique ray louver homogeneously so that the grains can be homogeneously irradiated in the inclined direction with the light.

Here will be described a third embodiment of the grain quality judging sample container. In this embodiment, light emitting diodes (LEDs) are used as the light source to irradiate the grains placed on the sample bed, in the oblique direction without using the oblique ray louver.

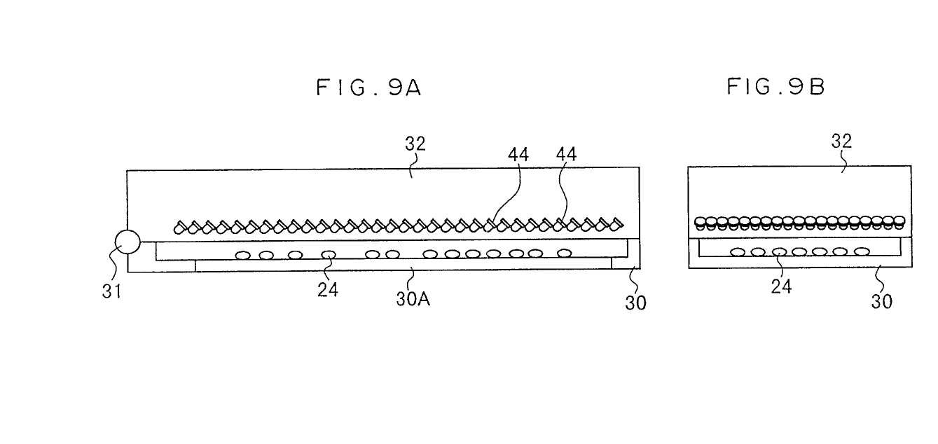

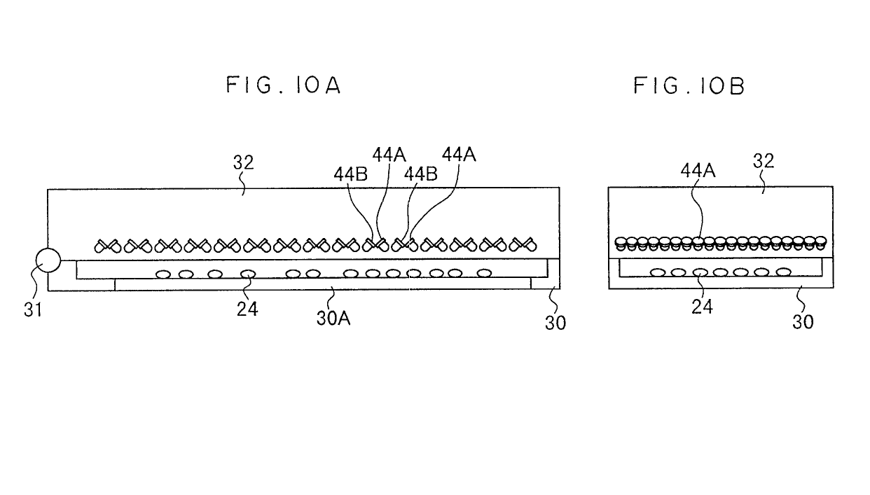

Inside of the cover 32, as shown in FIGS. 9A and 9B, numerous LEDs 44 are arranged in a two-dimensional shape (of n rows×m columns) with a light emitting direction, i.e., an optical axis direction being individually inclined within a range of 30 to 60 degrees, preferably 30 degrees with respect to the sample placing face of the sample bed 30. These LEDs are exemplified by monochromatic LEDs but may be modified by arranging LEDs of the three RGB colors alternately to produce a white light as a whole.

Here in this embodiment, all the LEDs are arrayed to have a common light emitting direction. As shown in FIGS. 10A and 10B, however, there may be alternately arranged one-dimensional LED arrays 44A and 44B which have opposite light emitting directions. In this case, the grains are illuminated obliquely in two different directions so that their quality can be judged more effectively.

This embodiment does not use the oblique ray louver so that the structure can be simplified.

Here will be described a fourth embodiment of the grain quality judging sample container. In this embodiment, an LED array is used as the light source and is moved in a direction to intersect the array direction of the LEDs thereby to irradiate all the grains placed on the sample bed, with the light in an inclined direction.

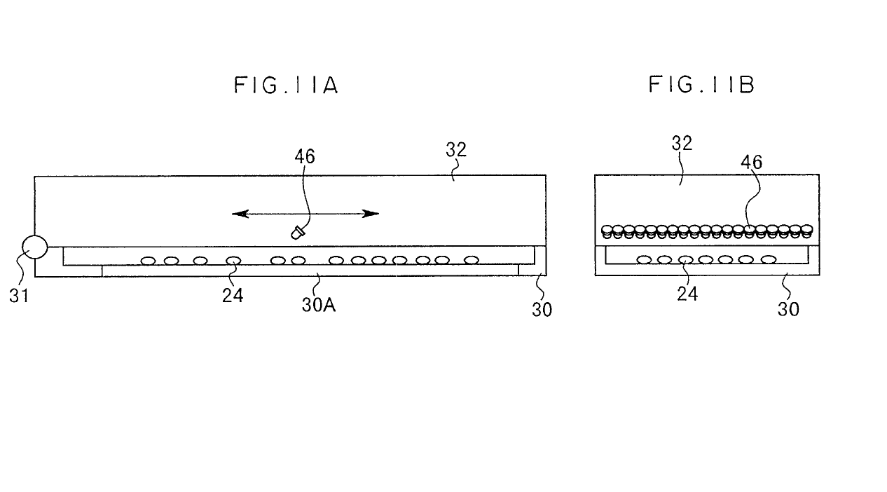

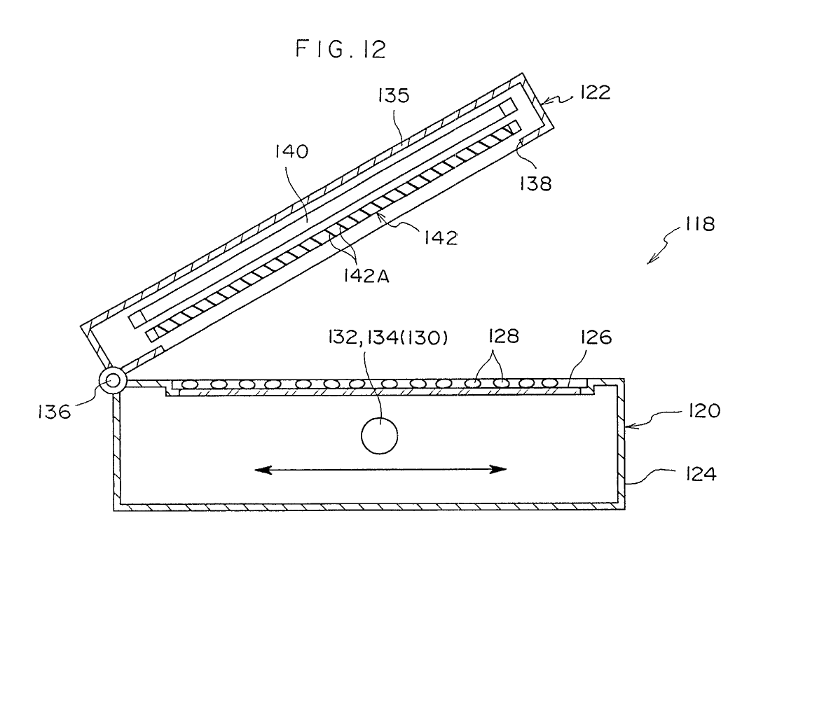

As shown in FIGS. 11A and 11B, the fourth embodiment is constructed by arranging an LED array 46, as composed of numerous light emitting elements arrayed in a one-dimensional direction with its light emitting direction being inclined with respect to the sample placing face of the sample bed, inside of the cover member 32 so that it can move in a direction to intersect the array direction of the LEDs. The mechanism to be used for moving the LED array 46 can be exemplified by the well-known drive mechanism such as a belt drive mechanism.

The grain quality judging sample container of this embodiment is mounted for use on the scanner, as described hereinbefore. At the image reading time, the scanning unit to be moved and the LED array are synchronously moved so that the portion to be illuminated with the light source of the scanner and the portion to be illuminated with the LED array may coincide, because the scanning unit is movably mounted on the scanner.

When the LED array is moved in this embodiment, the optical irradiation direction from the LED array may be so changed that the forward path and the backward path may have different optical irradiation directions. By these reciprocating movements, therefore, the grains are obliquely illuminated in two directions, as has been described with reference to FIGS. 10A and 10B, so that the grain quality can be judged more effectively.

This embodiment has been described in connection with the example using one LED array. However, there may be made movable the LED array in which the LED arrays 44A and the LED arrays 44B shown in FIG. 10A are combined to have opposite light emitting directions. Here in this embodiment, the sample bed may be moved while fixing the LED arrays, or the sample bed and the LED arrays may be moved in the opposite directions from each other.

Moreover, the foregoing individual embodiments may use organic EL elements in place of the LEDs.

With reference to FIGS. 12 to 17, here will be described embodiments of a grain image reading device according to the invention and a grain quality judging device using the reading device.

A color scanner 118 or a grain image reading device according to a fifth embodiment is used in place of the scanner 18 of the grain quality judging system 10.

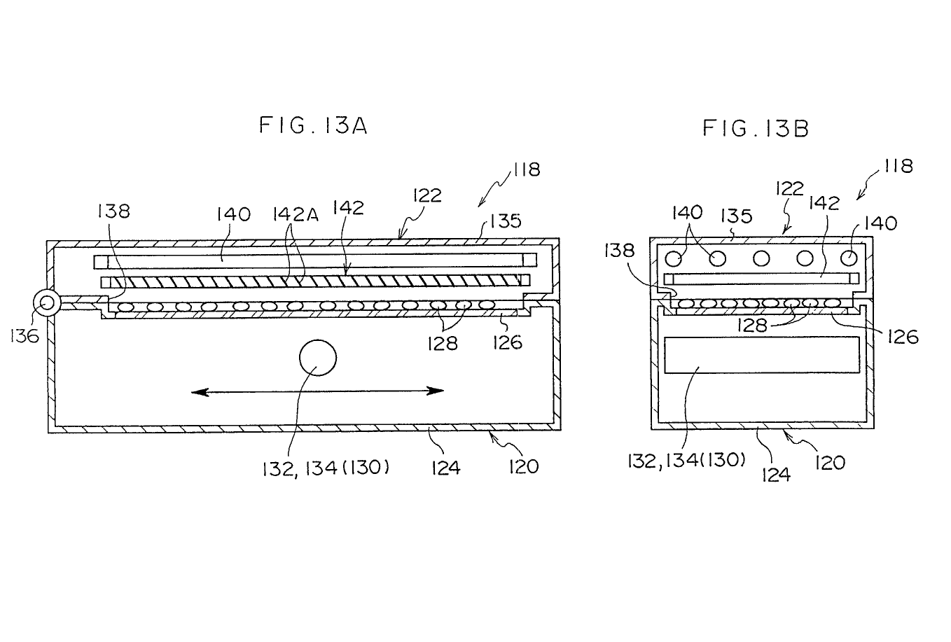

FIGS. 12 and 13 are sectional views showing a schematic construction of the color scanner 118. As shown, this color scanner 118 is constructed to include: a scanner body 120 having an image reading face on its upper end face; and a cover member 122 for covering the image reading face of the scanner body 120.

More specifically, the scanner body 120 is provided with a box-shaped casing 124. This casing 124 is opened mostly of its upper end face to arrange a sample bed 125 of glass removably. Here, the sample bed 126 need not always be made of a glass plate but may be made of an acrylic plate or a plate member made of another transparent material. The numerous grains (i.e., samples: grains of rice or wheat) 128 can be two-dimensionally placed on the sample bed 126 of the aforementioned construction.

In the casing 124 of the scanner body 120, moreover, there is arranged a scanning unit 130 as “scan means”. The scanning unit 130 is arranged to face the sample bed 126 and can move reciprocally (for the two-dimensional scan) in the directions of arrows of FIG. 12 along the bottom face of the sample bed 126. Moreover, the scanning unit 130 is constructed to include: an optical irradiation portion (or a light source) 132 for irradiating the grains 128 with the light; and a light receiving portion 134 for receiving both the transmitted light, which is irradiated with a light source 140 on the side of the later-described cover member 122 and transmitted through the grains 128 on the sample bed 126, and the reflected light which is irradiated from the optical irradiation portion 132 and reflected by the grains 128. In FIGS. 12 and so on, the entirety including the optical irradiation portion 132 and the light receiving portion 134 is designated by the scanning unit “130”. Moreover, the light receiving portion 134 of the scanning unit 130 is constructed to include color CCDs, and to decompose the image of the grains 128 placed on the sample bed 126 into the three RGB colors (i.e., red, green and blue colors) thereby to read and output them to the client computers 14.

On the other hand, the cover member 122 is provided with a relatively thin casing 135, which is hinged at its lower end one side to the upper end one side of the scanner body 120. Therefore, the cover member 122 can pivot around a hinge 136 so that it performs a function as a cover for opening/closing the image reading face of the scanner body 120. Here, the opening/closing type of the cover member 122 may be the hinge type as in this embodiment or may be a slide type or a composite type of the two. The lower end face of the cover member 122 is mostly opened, and a plurality of bar-shaped light sources 14 such as fluorescent lamps are arranged at a predetermined interval (as referred to FIG. 13B) deeply (i.e., inside of the cover member 122) in the opening 138.

At a position facing the opening 138 of the cover member 122, moreover, there is arranged an oblique ray louver 142 which is made of a plate member of plastics. This oblique ray louver 142 is arranged, with the cover member 122 being closed (as shown in FIG. 13A), to homogenize the direction of the light emitted from the light source 140, in the oblique direction so that the grains 128 placed on the upper face of the sample bed 126 may be irradiated with the light in the oblique direction. In the oblique ray louver 142, therefore, there are juxtaposed numerous optical paths 142A for transmitting the light therethrough in the oblique direction. The angle of inclination of the rays with respect to the bottom face of the sample bed 126, i.e., the angle of the optical paths 142A with respect to the bottom face of the sample bed 126 is preferably set within a range of about 30 degrees to about 60 degrees, of which the angle of about 30 degrees is appropriate. Moreover, the oblique ray louver 142 to be used can be exemplified by the “LIGHT CONTROL PANEL” (as known under the trade name of Edmond Scientific Japan Co., Ltd.).

Here, the light source 140 and the oblique ray louver 142 correspond to the “oblique ray means” in the invention.

Next, the actions and effects of this embodiment will be described in the following.

First of all, teaching is conducted by placing the grains 128 having a known grade (i.e., the grains of a nondefective grade) on the sample bed 126 so that the judgment result may be nondefective. When the grain quality and the judgment result are uncoincident, teaching is conducted to make the grain quality and the judgment result coincident by adjusting the minimum Rmin and the maximum Rmax of the R signal and the gradients a1, a2, b1 and b2 of a judgment table, in which two colors shown in FIGS. 5 to 7 are combined, for judging a predetermined grain quality. When the grains 128 of another grade are to be judged, the grains 128 classified into the grade to be judged may be placed on the sample bed 126, and the teaching may be made to ensure that the judgment result is nondefective. By these teachings, the grains 128 of a target grade can be judged as nondefective.

Next, the works are done for judging the quality of the grains 128 actually.

At first, the image of the grains 128 placed on the sample bed 126 is read. Specifically, the cover member 122 pivots around the hinge 136, and the numerous grains 128 are placed two-dimensionally on the sample bed 126. After this, the cover member 122 is closed. In this state, the scanning unit 130 of the scanner body 120 is driven and moved (for the two-dimensional scan) along the bottom face of the sample bed 126. As a result, the grains 128 are irradiated with the light from the optical irradiation portion 132 of the scanning unit 130, and the reflected light reflected by and returned from the grains 128 is received by the light receiving portion 134 of the scanning unit 130. The reception result of the reflected light is decomposed by the color CCDs constructing the light receiving portion 134 into the RGB (red, green and blue) colors, and these color components are output as the image (as will be called the “reflected image”) information to the client computer 14. Thus, the reflected image of the grains 128 can be obtained to read the states of the grain surface such as the contours or colors of the grains 128 so that the surface-troubled grains (i.e., the colored rice such as broken rice, unhulled rice, dead rice, brown-colored rice, blue immature rice, or rice damaged by insect pest) 128 can be inspected highly precisely.

Subsequently, the light source 140 on the side of the cover member 122 is lit to irradiate the grains 128 with the light. In the case of this embodiment, the oblique ray louver 142 is interposed between the light source 140 and the sample bed 126 so that the grains 128 are homogeneously irradiated with the irradiation light from the light source 140 obliquely within a range of about 30 degrees to 60 degrees. Thus, the grains 128 are obliquely irradiated with the light by using the oblique ray louver 142. This is because the light is easily shaded by the cracked or broken faces, if any in the grains 128, to form a shadow so that the state of the grain inside such as the cracked or broken faces can be read by reading that shadow thereby to enhance the precision of detecting the internally abnormal grains (or the cracked rice kernels) 128.

In the aforementioned state, the scanning unit 130 of the scanner body 120 is driven and moved like before (for the two-dimensional scan) along the bottom face of the sample bed 126. As a result, both the transmitted light emitted from the light source 140 on the side of the cover member 122 and transmitted through the grains 128 and the reflected light emitted from the optical irradiation portion 132 to irradiate the grains 128 and reflected by the grains 128 are received by the light receiving portion 134 of the scanning unit 130. In other words, this light receiving portion 134 of the scanning unit 130 receives both the transmitted light emitted from the light source 140 on the side of the cover member 122 and transmitted through the grains 128 and the reflected light emitted from the optical irradiation portion 132 on the side of the scanning unit 130 and reflected and returned by the grains 128, simultaneously. The reception results of the simultaneous receptions of the transmitted light and the reflected light are decomposed into and read as the RGB (i.e., the blue, green and blue colors) by the color CCDs composing the light receiving portion 134 and are output as the image (as will be called the “transmitted/reflected optical image”) information to the client computer 14.

On the basis of the image information thus obtained, the quality judging treatment of the grains 128 is done. Specifically, an inter-image operating treatment is done by subtracting the reflected optical image (or the received signal value) from the transmitted/reflected optical image (or the received signal value). Therefore, the transmitted optical image (or the received signal value) is obtained so that the state (e.g., the cracked/broken face) of the grain inside can be read to find out the internally abnormal grains (e.g., the cracked rice kernels) 128 highly precisely.

By performing the inter-image operations between the transmitted/reflected optical image and the reflected optical image, according to this embodiment, there can be extracted both the image information on the inside of the grains and the image information on the surface of the grains 128. In this case, the image information on the inside of the grains 128 can be determined from the result of the aforementioned inter-image operations, and the image information on the surface of the grains 128 can be determined from the reflected optical image. As a result, the cracked grain and the partially colored grain such as the white belly grain can be clearly judged to make the highly precise quality judgment.

Here, the image reading operations have been described by exemplifying the case in which the reflected optical image is read earlier whereas the transmitted/reflected optical image is read later. However, the operations should not be limited thereto, but the image of the grains 128 may be read in the reversed sequence.

The aforementioned manner how to judge the quality of the grains 128 is similar to that of the first embodiment.

Thus in the color scanner 118 according to this embodiment, the sample bed 126 is arranged on the side of the scanner body 120, and the cover member 122 is integrated with the scanner body 120, so that the image of the grains 128 is read by using two kinds of lights: the transmitted light using the light source 140 and the oblique ray louver 142 on the side of the cover member 122; and the reflected light using the optical irradiation portion 132 of the scanning unit 130 on the side of the scanner body 120. Therefore, it is possible to detect both the cracked rice kernel and the colored rice highly precisely. As a result, the quality judging precision of the grains 128 can be improved by adopting a grain quality judging device 110 using the color scanner 118.

Especially the color scanner 118 according to this embodiment is constructed to irradiate the grains obliquely with the light by using the oblique ray louver 142. When the grains 128 are internally cracked/broken, therefore, the shadow is easily formed in the grains 128 so that the judging precision (or the quality judging precision) of the cracked rice kernel can be enhanced by reading that shadow.

In the color scanner 118 according to this embodiment, moreover, the sample bed 126 is arranged on the side of the scanner body 120 so that the cover member 122 can be small-sized and made light. In other words, the cover member 122 would exceed, if provided with the sample bed 126 on its side, the size called the “cover member” to the concept of the “box”. By arranging the sample bed 126 on the side of the scanner body 120 as in this embodiment, the size and weight can be reduced from those of the “box” to those of the “cover member”. As a result, the cover member 122 can be openably attached to the sample bed 126 of the scanner body 120, and these two members can also be integrated.

In the color scanner 118 according to this embodiment, moreover, the irradiation direction is so regulated by using the oblique ray louver 142 as to irradiate the grains 128 homogeneously in the oblique direction with the irradiation light coming from the light source 140. Therefore, it is unnecessary to make a device for the oblique ray on the side of the light source 140. As a result, it is possible according to this embodiment to simplify the internal structure of the cover member 122 and to facilitate the manufacture of the cover member 122.

In the grain quality judging system 10 according to this embodiment, moreover, the image information at the time when only the transmitted light is received is determined by performing the inter-image operations between the transmitted/reflected optical image and the reflected optical image, as read by using the color scanner 118. Therefore, it is possible to utilize the existing the scanning unit 130. As a result, it is possible to provide the grain quality judging system 10 at a reasonable cost.

Here will be described sixth to ninth embodiments of the grain image reading device according to the invention. Here, the description of the construction portions identical to those of the fifth embodiment will be omitted by designating them by the common reference numerals.

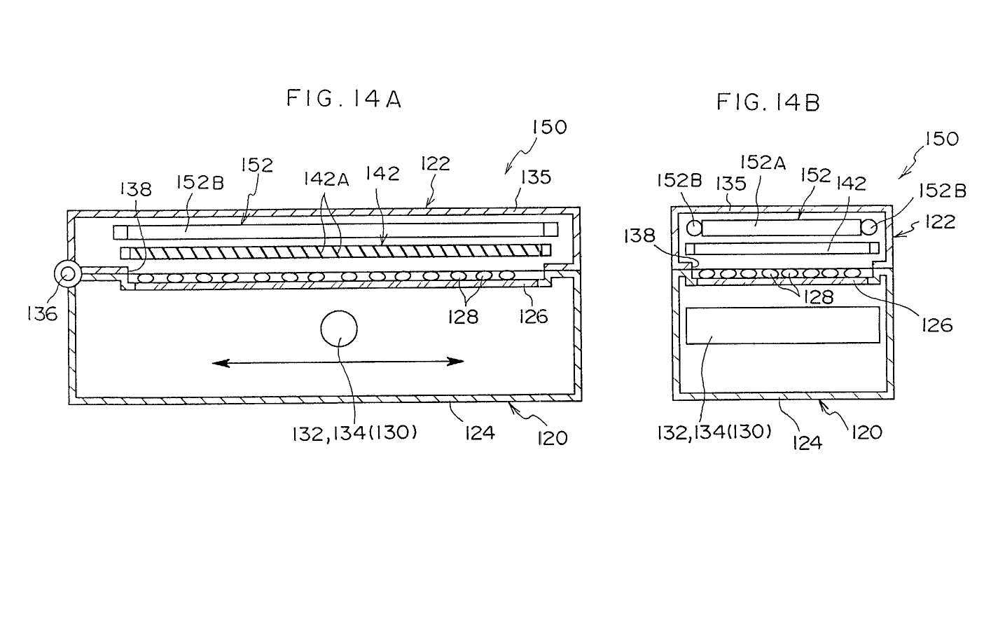

A color scanner 150, as shown in FIGS. 14A and 14B, is characterized in that a surface light source 152 is used in place of the bar-shaped light source 140 on the side of the cover member 122. The surface light source 152 is constructed, as shown in FIG. 14B, to include: a rectangular diffusing plate 152A arranged in parallel with the oblique ray louver 142; and a pair of bar-shaped light sources 152B disposed on the opposed sides of the diffusing plate 152A.

When the bar-shaped light sources 152B are turned ON, according to the construction, their lights propagate through the diffusing plate 152A and are emitted as the diffused lights from the upper and lower faces of the diffusing plate 152A. These diffused lights are obliquely homogenized in the direction by the oblique ray louver 142 to irradiate the grains 128 placed on the sample bed 126 with the oblique direction. Therefore, the irradiation lights with respect to the oblique ray louver 142 are more homogenized than those using the bar-shaped light source 140 thereby to enhance the homogeneity of the optical irradiation of the grains 128 placed on the sample bed 126, in the oblique direction.

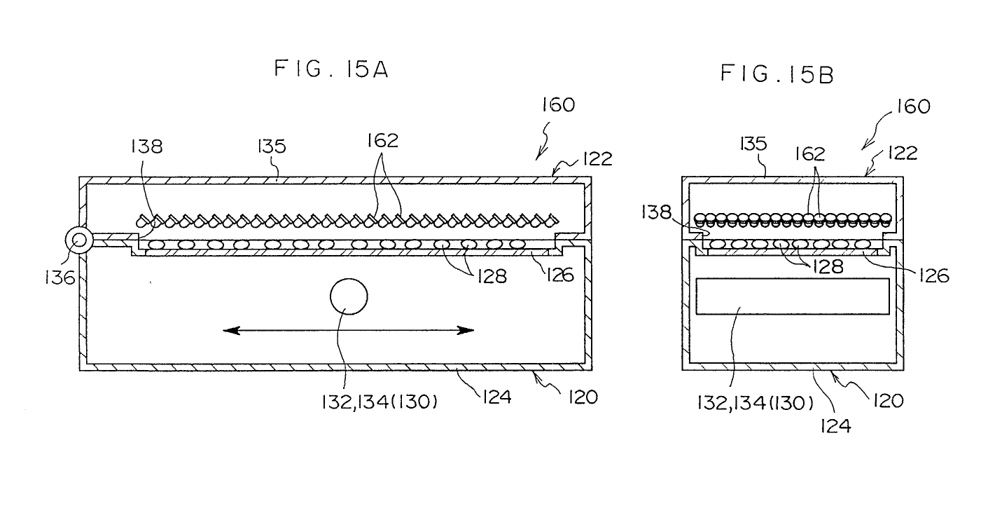

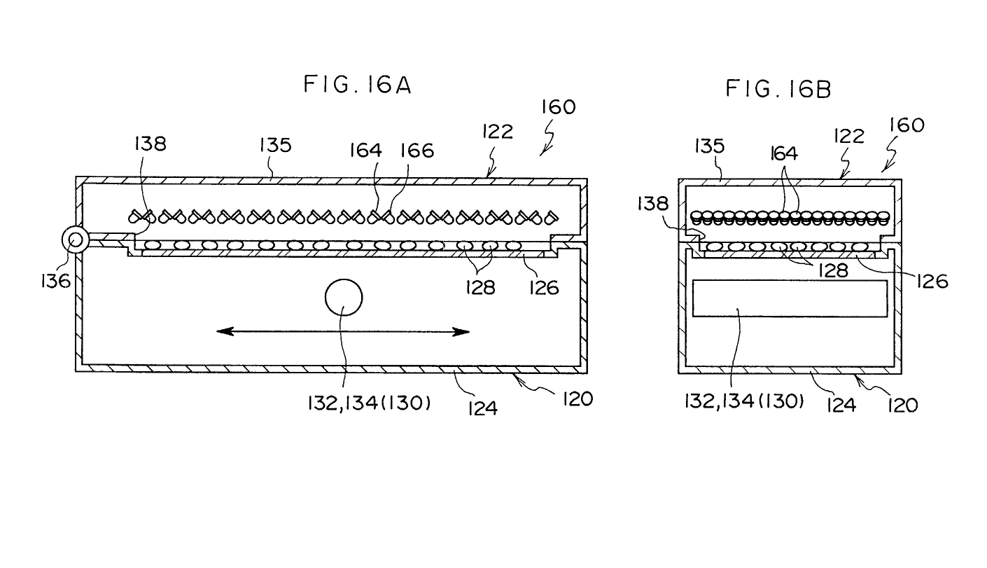

A color scanner 160, as shown in FIGS. 15A and 15B, is characterized in that numerous light emitting diodes (LEDs) 162 are arranged at a two-dimensional inclination in place of the light source 140 and the oblique ray louver 142 on the side of the cover member 122. Specifically, the optical axis direction of the individual light emitting diodes 162 is set within a range of about 30 degrees to about 60 degrees, preferably about 30 degrees with respect to the sample placing face of the sample bed 126, and the numerous light emitting diodes 162 are arranged in a two-dimensional shape (of n rows×m columns). Here in this embodiment, the monochromatic light emitting diodes 162 are used but may be modified by arranging the light emitting diodes 162 of the three RGB colors alternately to produce a white light as a whole.

With this construction in which the numerous light emitting diodes 162 are two-dimensionally arranged at the inclination of a predetermined angle, the oblique ray louver 142 can be dispensed with. As a result, the structure on the side of the cover member 122 can be simplified according to this embodiment.

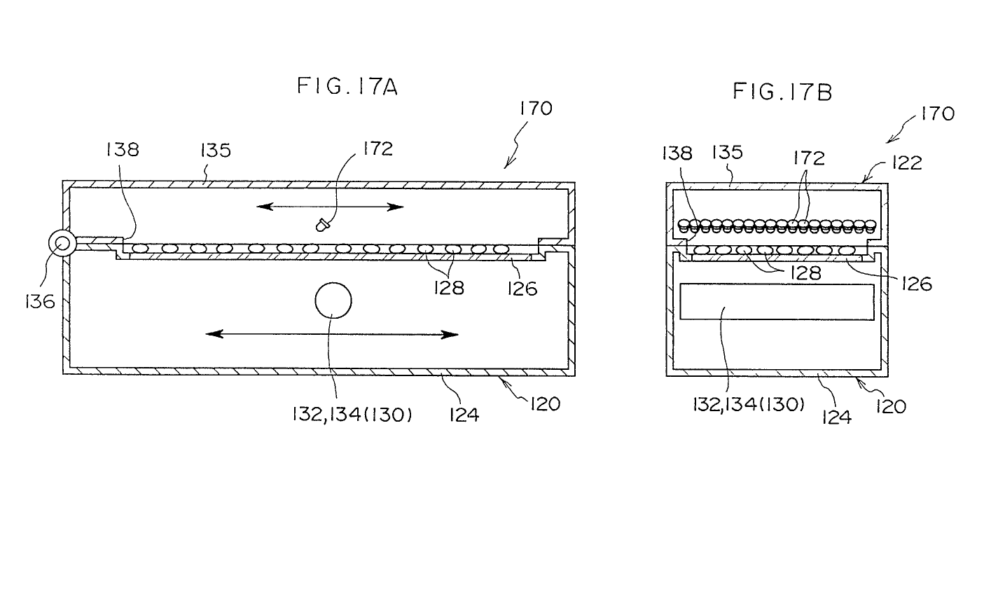

Here in this embodiment, all the light emitting directions (or the optical axis directions) of the light emitting diodes 162 are set in the common direction. As shown in FIGS. 16A and 16B, however, the construction may be modified into such one (i.e., an eighth embodiment) that one-dimensional light emitting diode arrays 164 and 166 having opposite light emitting directions are alternately arrayed. In this modification, the grains 128 are irradiated obliquely with lights of two different directions so that their quality can be judged more effectively.

A color scanner 170 (of a ninth embodiment), as shown in FIGS. 17A and 17B, is characterized in that light emitting diode array 172 arranged in a one-dimensional direction and inclined individually is arranged in place of the light source 140 and the oblique ray louver 142 on the side of the cover member 122, and in that the light emitting diode array 172 is moved in a direction (i.e., in the direction of arrows of FIG. 17A) to intersect (at a right angle) its array direction. A well-known drive mechanism such as a belt drive mechanism can be applied to the mechanism for moving the one-dimensional light emitting diode array 172.

According to this construction, the grains 128 are irradiated obliquely with the lights emitted from the light emitting diode array 172 arranged in the one-dimensional direction so that the one-dimensional oblique ray properties can be retained. In order to develop this one-dimensional irradiation to the two-dimensional one, moreover, it is sufficient to move the light emitting diode array 172 in a direction to intersect the array direction of the light emitting diode array 172. At this time, the scanning unit 130 and the light emitting diode array 172 are so synchronously moved that the portion to be irradiated with the optical irradiation portion 132 of the scanner body 120 and the portion to be irradiated with the light emitting diode array 172 may become coincident. With the light emitting diode array 172 being left unmoved, alternatively, the sample bed 126 may be moved in the direction to intersect the array direction of the light emitting diode array 172. In this modification, the scanning unit 130 is held at a position to correspond to the light emitting diode array 172. There may be adopted another construction in which the light emitting diode array 172 and the sample bed 126 are moved in the opposite directions from each other. By adopting any of these methods, according to this embodiment, not only the oblique ray louver 142 can be dispensed with, but also the number of the light emitting diode array 172 to be used can be drastically reduced. As a result, the cost can be drastically lowered according to this embodiment.

Here in the constructions thus far described, the optical irradiation direction of the light emitting diode array 172 may be changed between the forward path and the backward path. In this case, the grains 128 are illuminated obliquely in the two different directions, as described with reference to FIGS. 16A and 16B, by the reciprocal movements of the light emitting diode array 172 so that the quality of the grains 128 can be judged more effectively.

Moreover, the forgoing constructions have been described on the case in which one light emitting diode array 172 is used. However, there may be made movable the light emitting diode arrays 164 and 166 (i.e., the light emitting diode arrays combined to have light emitting directions opposed to each other) which have the construction shown in FIG. 16A.

Moreover, the individual embodiments, as shown in FIGS. 15 to 17, use the light emitting diodes 162 and the light emitting diode arrays 164, 166 and 172. However, the invention should not be limited thereto but may use organic EL elements.

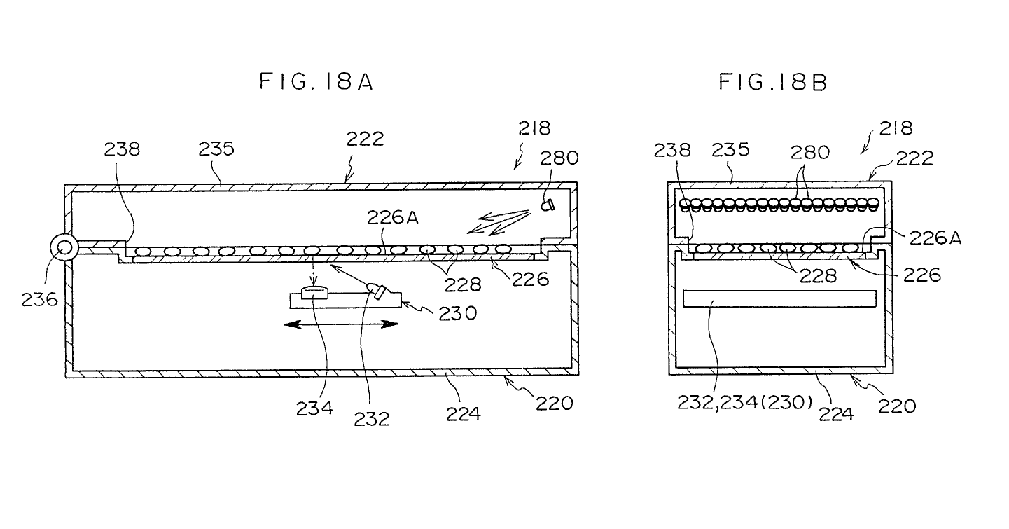

An embodiment of the grain image reading device according to the invention will be described with reference to FIGS. 18 to 21. A color scanner 218 exemplifying the “grain image reading device” according to a tenth embodiment is used in place of the scanner 18 in the grain quality judging system 10.

FIGS. 18A and 18B are sectional views showing a schematic construction of the color scanner 218. As shown in FIGS. 18A and 18B, the color scanner 218 is constructed to include: a scanner body 220 having an image reading face on its upper end face; and a cover member 222 for covering the image reading face of the scanner body 220.

More specifically, the scanner body 220 is provided with a box-shaped casing 224. This casing 224 is mostly opened in its upper end face, in which a sample bed 226 of glass is removably arranged. Here, the sample bed 226 need not always be made of a glass plate but may be made of an acryl plate or a plate of another transparent material. On the sample bed 226 thus constructed, there can be two-dimensionally arranged numerous grains (i.e., the samples such as hulled rice) 228.

In the casing 224 of the scanner body 220, moreover, there is arranged a scanning unit 230 acting as the “scan means”. The scanning unit 230 is so arranged to face the sample bed 226 as can reciprocate (for the two-dimensional scan) in directions of arrows of FIG. 18A along the bottom face of the sample bed 226. Moreover, the scanning unit 230 is constructed to include: an optical irradiation portion (or a light source) 232 for irradiating the grains 228 with a light; and a light receiving portion 234 for receiving both the transmitted light emitted from a light source 280 on the side of the later-described cover member 222 and transmitted through the grains 228 on the sample bed 226 and the reflected light emitted from the optical irradiation portion 232 and reflected by the grains 228. Here in FIG. 18B, the entirety including the optical irradiation portion 232 and the light receiving portion 234 is designated by the scanning unit “230”. Moreover, the light receiving portion 234 of the scanning unit 230 is constructed to include color CCDs and to decompose the image of the grains 228, as placed on the sample bed 226, into the three RGB colors (i.e., the red, green and blue colors) thereby to read and output them to the client computer 14.

On the other hand, the cover member 222 is provided with a relatively thin casing 235, which is hinged at its one lower end side to one upper end side of the scanner body 220. Therefore, the cover member 222 can pivot around a hinge 236 so that it performs the function as a cover for opening/closing the image reading face of the scanner body 220. Here, the opening/closing type of the cover member 222 may be the hinge type as in this embodiment or may be a slide type or a composite type of the two. The lower end face of the cover member 222 is mostly opened to form an opening 238, in which the light source 280 composed of light emitting diode array in a one-dimensional direction is arranged deeply thereof.

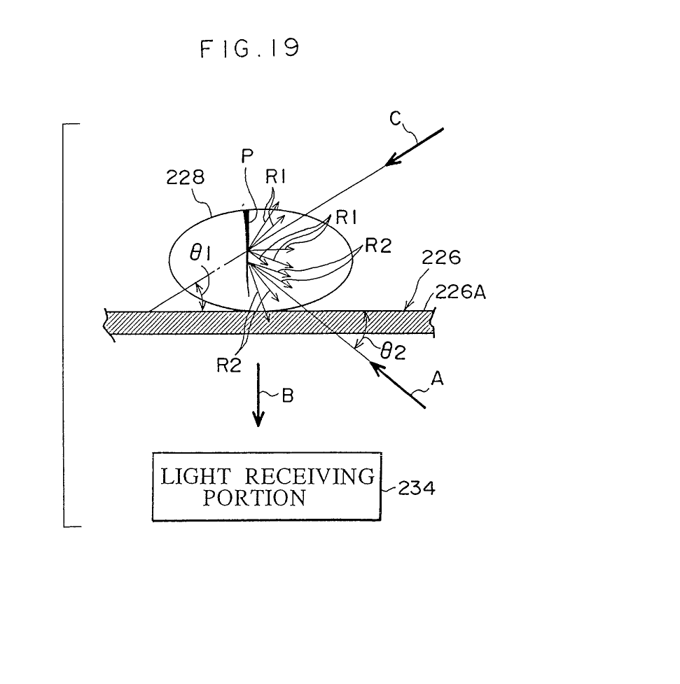

Here in this embodiment, the light source 280 is fixed on the end side of a sample placing face 226A of the sample bed 226 in the cover member 222. As shown in FIG. 19, moreover, the optical axis direction (i.e., the direction of an irradiation light C) of the light source 280 is inclined at a predetermined angle θ1 with respect to the sample placing face 226A of the sample bed 226. On the other hand, the optical axis direction (i.e., the direction of an irradiation light A) of the scanning unit 230 is also inclined at a predetermined angle θ2 with respect to the sample placing face 226A of the sample bed 226.

The inclination angles θ1 and θ2 will be described in the following. Here, the “inclination” means the inclination of a light, at which the irradiation light C from the light source 280 and the irradiation light A from the optical irradiation portion 232 irradiate the internally cracking plane P of the grains (of the cracked rice kernel) 228 “obliquely”. This “inclination” has two effects: (1) Random reflections easily occur in the internal cracking plane P of the grains; and (2) The grains 228 can be irradiated, even closely arranged, with the light even through their clearances. In an extreme example, the random reflections are hard to occur in the internal cracking plane P even in case the grains (of the cracked rice kernels) 228 are irradiated with a light right overhead. In this case, therefore, the effect (1) cannot be attained but is excluded. In case the closely arranged grains 228 are irradiated with a light just beside, on the contrary, the trailing grains (of the cracked rice kernels) are hidden by the leading grains 228 so that the light cannot reach the internal cracking plane P. In this case, therefore, the effect (2) cannot be attained but is excluded.

Here will be described the actions and effects of this embodiment.

First of all, the basic actions (or the entire actions) of the color scanner 218 according to this embodiment will be described in the following.

First of all, teaching is conducted by placing the grains 228 having a known grade (i.e., the grains of a nondefective grade) on the sample bed 226 so that the judgment result may be nondefective. When the grain quality and the judgment result are uncoincident, teaching is conducted to make the grain quality and the judgment result coincident by adjusting the minimum Rmin and the maximum Rmax of the R signal and the gradients a1, a2, b1 and b2 of a judgment table, in which two colors shown in FIGS. 5 to 7 are combined, for judging a predetermined grain quality. When the grains 228 of another grade are to be judged, the grains 228 classified into the grade to be judged may be placed on the sample bed 226, and the teaching may be made to ensure that the judgment result is nondefective. By these teachings, the grains 228 of a target grade can be judged as nondefective.

Next, the works are done for judging the quality of the grains 228 actually.

At first, the image of the grains 228 placed on the sample bed 226 is read. Specifically, the cover member 222 pivots around the hinge 236, and the numerous grains 228 are placed two-dimensionally on the sample bed 226. After this, the cover member 222 is closed. In this state, the scanning unit 230 of the scanner body 220 is driven and moved (for the two-dimensional scan) along the bottom face of the sample bed 226. As a result, the grains 228 are irradiated with the light from the optical irradiation portion 232 of the scanning unit 230, and the reflected light reflected by and returned from the grains 228 is received by the light receiving portion 234 of the scanning unit 230. The reception result of the reflected light is decomposed by the color CCDs constructing the light receiving portion 234 into the RGB (red, green and blue) colors, and these color components are output as the image (as will be called the “reflected image”) information to the client computer 14. Thus, the reflected image of the grains 228 can be obtained to read the states of the grain surface such as the contours or colors of the grains 228 so that the surface-troubled grains (i.e., the colored rice such as broken rice, unhulled rice, dead rice, brown-colored rice, blue immature rice, or rice damaged by insect pest) 228 can be inspected highly precisely.

Subsequently, the light source 280 on the side of the cover member 222 is lit to irradiate the grains 228 with the light. In the case of this embodiment, the light source 280 is constructed of the one-dimensional light emitting diode array having an optical axis inclined at a predetermined angle with respect to the sample placing face 226A so that the grains 228 are obliquely irradiated with the irradiation light from the light source 280. Thus, the grains 228 are obliquely irradiated with the light. This is because the light is easily shaded by the cracked or broken faces, if any in the grains 228, to form a shadow so that the state of the grain inside such as the cracked or broken faces can be read by reading that shadow thereby to enhance the precision of detecting the internally abnormal grains (or the cracked rice kernels) 228.

In the aforementioned state, the scanning unit 230 of the scanner body 220 is driven and moved like before (for the two-dimensional scan) along the bottom face of the sample bed 226. As a result, both the transmitted light emitted from the light source 280 on the side of the cover member 222 and transmitted through the grains 228 and the reflected light emitted from the optical irradiation portion 232 to irradiate the grains 228 and reflected by the grains 228 are received by the light receiving portion 234 of the scanning unit 230. In other words, this light receiving portion 234 of the scanning unit 230 receives both the transmitted light emitted from the light source 280 on the side of the cover member 222 and transmitted through the grains 228 and the reflected light emitted from the optical irradiation portion 232 on the side of the scanning unit 230 and reflected and returned by the grains 228, simultaneously. The reception results of the simultaneous receptions of the transmitted light and the reflected light are decomposed into and read as the RGB (i.e., the blue, green and blue colors) by the color CCDs composing the light receiving portion 234 and are output as the image (as will be called the “transmitted/reflected optical image”) information to the client computer 14.

On the basis of the image information thus obtained, the quality judging treatment of the grains 228 is done. Specifically, an inter-image operating treatment is done by subtracting the reflected optical image (or the received signal value) from the transmitted/reflected optical image (or the received signal value). Therefore, the transmitted optical image (or the received signal value) is obtained so that the state (e.g., the cracked/broken face) of the grain inside can be read to find out the internally abnormal grains (e.g., the cracked rice kernels) 228 highly precisely.

By performing the inter-image operations between the transmitted/reflected optical image and the reflected optical image, according to this embodiment, there can be extracted both the image information on the inside of the grains and the image information on the surface of the grains 228. In this case, the image information on the inside of the grains 228 can be determined from the result of the aforementioned inter-image operations, and the image information on the surface of the grains 228 can be determined from the reflected optical image. As a result, the cracked grain and the partially colored grain such as the white belly grain can be clearly judged to make the highly precise quality judgment.

Here, the image reading operations have been described by exemplifying the case in which the reflected optical image is read earlier whereas the transmitted/reflected optical image is read later. However, the operations should not be limited thereto, but the image of the grains 228 may be read in the reversed sequence. In the case of this embodiment, moreover, the light source 280 is fixed at the predetermined position in the cover member 222 from the viewpoint for the lower cost, so that the lightness becomes different between the portions closer to and apart from the light source 280. This lightness different is corrected by means of a software.

The fundamental actions of the color scanner 218 according to this embodiment and the grain quality judging system 10 using the former have been described hereinbefore, but the actions to be described in the following can also be attained according to the embodiment.

In the invention, more specifically, the optical axis direction of the light source 280 is inclined at the predetermined angle θ1 with respect to the sample placing face 226A of the sample bed 226, as has been described with reference to FIG. 19. Therefore, the light C, as emitted from the light source 280, comes obliquely into the internal cracking plane P of the grains (of the cracked rice kernels) 228 and are randomly reflected (as the randomly reflected rays R1 in FIG. 19) on the internal cracking plane P. Therefore, the quantity of the randomly reflected rays R1 to be received by the light receiving portion 234 of the scanning unit 230 increases. Here in this embodiment, the light source 280 is disposed on the end side of the sample placing face 226A of the sample bed 226 in the cover member 222 so that all the grains 228 placed on the sample placing face 226A of the sample bed 226 can be irradiated obliquely with the light C.

On the other hand, the optical axis direction of the optical irradiation portion 232 of the scanning unit 230 is also inclined at the predetermined angle θ2 with respect to the sample placing face 226 of the sample bed 226 (although the light A emitted from the optical irradiation portion 232 should be basically reflected on the surfaces of the grains 228 and received by the light receiving portion 234). Therefore, a portion of the light A is not reflected on the surfaces of the grains (of the cracked rice kernels) 228 but is obliquely incident upon the internal cracking plane P so that it is randomly reflected (as randomly reflected rays R2 of FIG. 19) on the internal cracking plane P. Therefore, there increases the quantity of the randomly reflected rays R2 to be received by the light receiving portion 234 of the scanning unit 230.

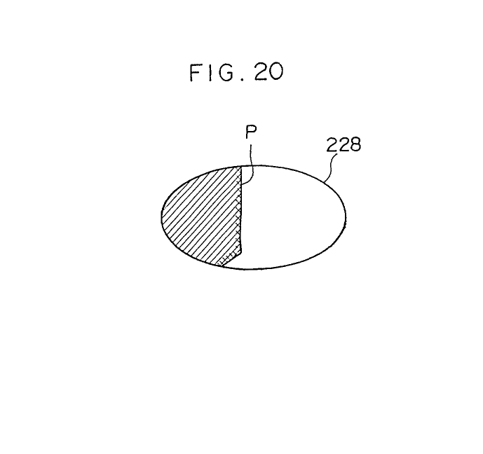

According to this embodiment, more randomly reflected rays (R1+R2) can be produced on the internal cracking plane P of the grains (of the cracked rice kernels) to give intensity differences of a light B (as referred to FIG. 19) (or to intensify the light B) to be received by the light receiving unit 234. As a result, according to this embodiment, the internal cracking plane P of the grains 228 can be clearly projected as a lightness difference in an image, as illustrated in FIG. 20.

Thus in the color scanner 228 according to this embodiment, the sample bed 226 is arranged on the side of the scanner body 220, and the cover member 222 is integrated with the scanner body 220, so that the image of the grains 228 is read by using two kinds of lights: the transmitted light using the light source 280 on the side of the cover member 222; and the reflected light using the optical irradiation portion 232 of the scanning unit 230 on the side of the scanner body 220. Therefore, it is possible to detect both the cracked rice kernel and the colored rice highly precisely. As a result, the quality judging precision of the grains 228 can be improved by adopting a grain quality judging system 10 using the color scanner 228.

Especially in the color scanner 218 according to this embodiment, the light source 280 is fixed on the end side of the sample placing face 226A of the sample bed 226 in the cover member 222, and the optical axis direction of the light source 280 is inclined at the predetermined angle θ1 with respect to the sample placing face 226A of the sample bed 226 whereas the optical axis direction of the optical irradiation portion 232 of the scanning unit 230 is also inclined at the predetermined angle θ2 with respect to the sample placing face 226A of the sample bed 226. In case the cracking plane P exists in the grains 228, therefore, it can be reflected as the lightness difference on the image. Therefore, the color scanner 218 according to this embodiment can enhance the judging precision of the cracked rice kernels especially so that it is remarkably excellent from this viewpoint in that it can improve the quality judging precision of the grains 228.

Here will be described an eleventh embodiment of the grain image reading device according to the invention. The description of the components identical to those of the tenth embodiment will be omitted by designating them by the common reference numerals.

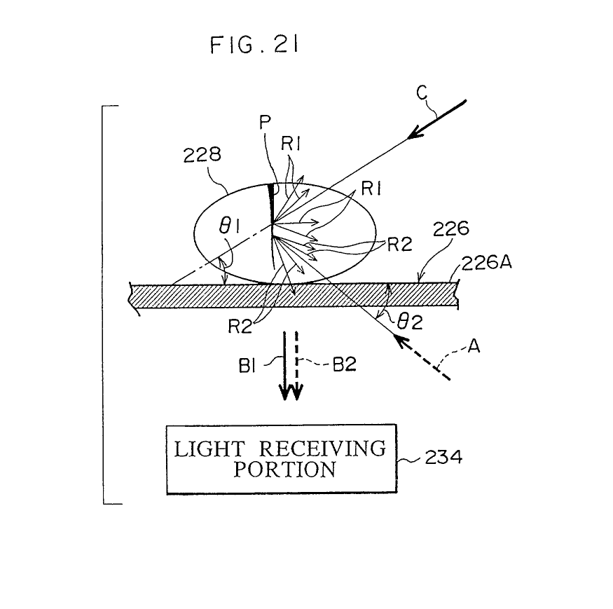

As shown in FIG. 21, this embodiment is characterized in that the optically irradiation portion 232 of the scanning unit 230 and the light source 280 on the side of the cover member 222 can be turned ON/OFF independently of each other.

According to this construction, there can be obtained three ways of optical irradiation modes, from which an arbitrary one can be selected.

In case only the light source 280 is turned ON, for example, there is established a mode, in which the light C emitted from the light source 280 is obliquely incident upon the internal cracking plane P of the grains 228 so that only the randomly reflected rays R1 reflected randomly on the internal cracking plane P are received by the light receiving portion 234. In this mode, therefore, the light B to be received by the light receiving portion 234 is designated by B1. In case the light source 280 is turned OFF whereas only the optical irradiation portion 232 is turned ON, on the contrary, there is established a mode, in which a portion of the light A emitted from the optical irradiation portion 232 is obliquely incident upon the internal cracking plane P of the grains 228 so that only the randomly reflected rays R2 reflected randomly on the internal cracking plane P is received by the light receiving portion 234. In this mode, therefore, the light B to be received by the light receiving portion 234 is designated by B2. In case both the light source 280 and the optical irradiation portion 232 are turned ON, moreover, there is established a mode, in which both the lights A and C are obliquely incident upon the internal cracking plane P of the grains 228 so that the randomly reflected rays R1 and R2 reflected randomly on the internal cracking plane P are received by the light receiving portion 234. In this case, therefore, the light B to be received by the light receiving portion 234 is B1+B2.

Here, these three modes are compared from the viewpoint of the clearness of the internal cracking plane P. The most dominant mode is the third one, in which the light receiving intensity of the randomly reflected rays is the most intense; the next dominant mode is the first one; and the next dominant mode is the second one.

Thus, according to this embodiment, it is possible to select the optical irradiation mode according to the needs.

The grain quality judging system 10 according to the fifth to eleventh embodiments is constructed such that the color scanners 118 or 218 is connected with the client computer 14, and such that the client computer 14 is connected with the network 12. However, the invention should not be limited to that construction but may adopt a construction in which a stand-alone type computer for functioning as a judging device is used as the client computer 14 but not connected with the network 12.

Moreover, the grain quality judging system 10 according to the fifth to eleventh embodiments is constructed such that the transmitted optical image is obtained by reading the transmitted/reflected optical image and the reflected optical image and by performing the inter-image operations in the client computer 14. However, the invention should not be limited thereto but may adopt the following methods.

One is a method for obtaining a reflected optical image by reading the transmitted optical image and by performing the inter-image operations, as contrary to the aforementioned one. Specifically, the optical irradiation portion 132 or 232 of the scanning unit 130 or 230 are so constructed as can be turned ON/OFF. With both the light source of the oblique ray means and the optical irradiation portion 132 or 232 being turned ON, there is obtained the image information (or the transmitted/reflected optical image information) at the time when both the transmitted light which is emitted from the former light source and transmitted through the grains 128 or 228 and the reflected light which is emitted from the latter and reflected by the grains 128 or 228 are received by the light receiving portion 134 or 234. With the light source of the oblique ray means being turned ON but with the optical irradiation portion 132 or 232 being turned OFF, moreover, there is obtained the image information (or the transmitted optical image information) at the time when only the transmitted light which is emitted from the former and transmitted through the grains 128 or 228 is received by the light receiving portion 134 or 234. Moreover, these pieces of image information are output to the client computer 14, in which the reflected optical image is determined by subtracting the transmitted optical image from the transmitted/received optical image. By this method, too, it is possible to make a quality judgment of a high precision similar to that of each of the previous embodiments.

According to another method, as in the aforementioned method, the optical irradiation portion 132 or 232 of the scanning unit 130 or 230 are so constructed as can be turned ON/OFF. With the light source of the oblique ray means being turned ON but with the optical irradiation portion 132 or 232 being turned OFF, there is obtained the image information (or the transmitted optical image information) at the time when only the transmitted light which is emitted from the former light source and transmitted through the grains 128 or 228 is received by the light receiving portion 134 or 234. With the light source of the oblique ray means being turned OFF but with the optical irradiation portion 132 or 232 being turned ON, moreover, there is obtained the image information (or the reflected optical image information) at the time when only the reflected light which is emitted from the latter and reflected by the grains 128 or 228 is received by the light receiving portion 134 or 234. Moreover, these pieces of image information are outputted to the client computer 14. According to this construction, the transmitted optical image information and the reflected optical image information are individually obtained directly so that the inter-image operations need not be done. Therefore, the client computer 14 can judge the quality of the grains 128 or 228 directly from the two kinds of input image information. Therefore, the quality of the grains 128 or 228 can be judged for such a time period as is shortened because the inter-image operations are not needed.

In the color scanner 218 according to the aforementioned tenth and eleventh embodiments, there is used the light source 280 which is constructed of the light emitting diode array. However, the invention should not be limited thereto but may use a bar-shaped light source (e.g., a fluorescent lamp).

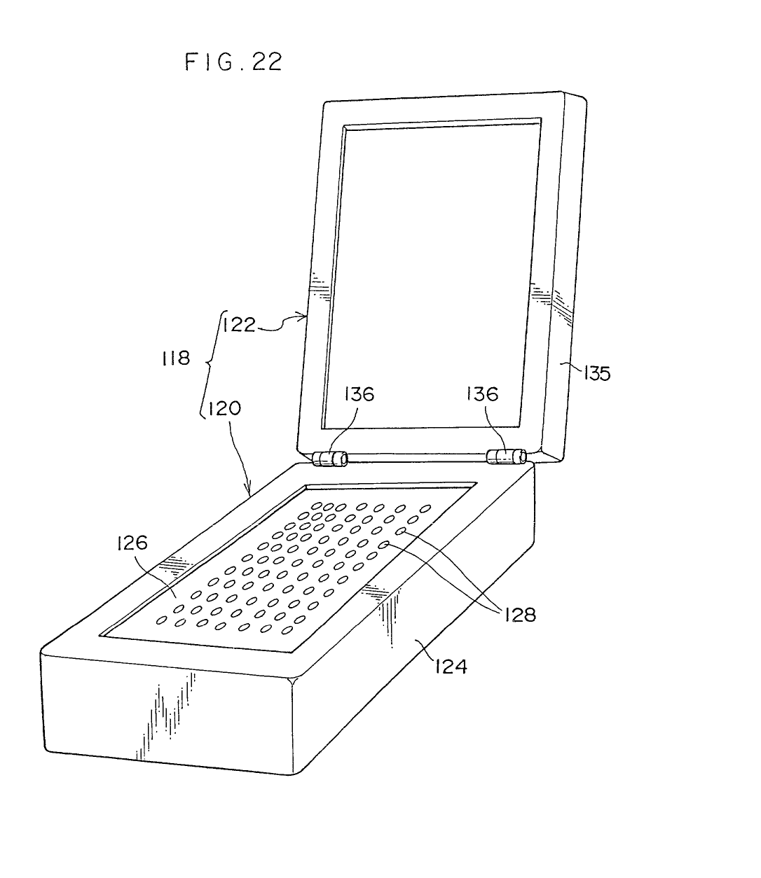

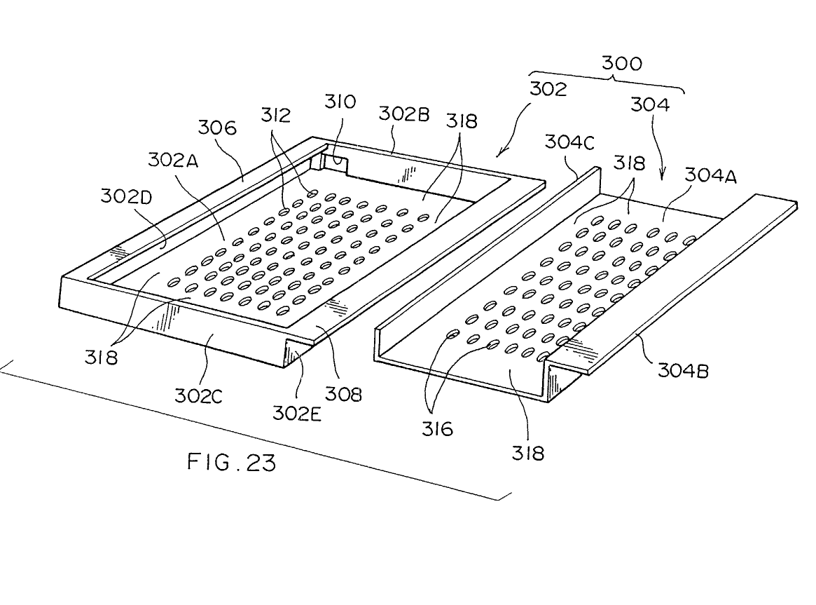

With reference to FIGS. 22 to 26, here will be described embodiments of a sample arraying jig for a grain image reading device and a sample arraying method using the jig.

A sample arraying jig 300 is provided for placing the grains 128 in an arrayed state on the upper face (or the sample placing face) of the sample bed 126 of the aforementioned color scanner 118, and can be used in the color scanner 118 of the fifth to ninth embodiments.

FIG. 22 is a perspective view of the color scanner 118. When the cover member 122 pivots around the hinge 136 and is opened, the sample bed 126 appears so that the sample arraying jig 300 shown in FIG. 23 is set on the upper face of the sample bed 126.

The sample arraying jig 300 is constructed to include: a sample arraying jig body 302 formed generally into a tray shape; and a moving member 304 placed on the sample arraying jig body 302. Here, the sample arraying jig body 302 and the moving member 304 may be made of a resin or a metal.

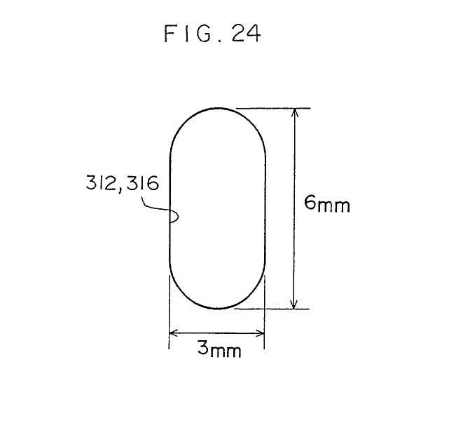

The sample arraying jig body 302 is constructed to include: a bottom wall portion 302A formed into the same shape as that of the upper face of the sample bed 126; and shorter side wall portions 302B and 302C and longer side wall portions 302D and 302E raised from the peripheral edge portions of that bottom wall portion 302A. On one longer sidewall portion 302D, there is formed a return 306 which is extended toward the other longer side wall portion 302E. On the other longer side wall portion 302E, moreover, there is formed a grip 308 which is extended to the outside. On one side wall portion 302B, moreover, there is formed a rectangular discharge port 310 which is located near the return 306. In the bottom wall portion 302A, moreover, there are formed a number of (e.g., 1,000) first holes 312. As shown in FIG. 24, the first holes 312 are formed into such a track shape having a length of 6 mm and a width of 3 mm as can admit a grain 128.

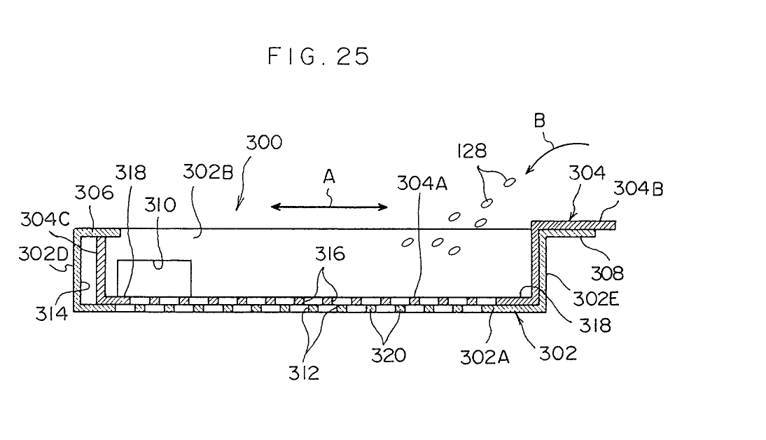

Reverting to FIG. 23, the moving member 304 is constructed to include: a rectangular flat base portion 304A to be placed on the bottom wall portion 302A of the sample arraying jig body 302; a step-shaped grip 304B formed at one longer side portion of the base portion 304A; and a rising portion 304C raised from the other longer side portion of the base portion 304A. With the moving member 304 being fitted in the sample arraying jig body 302, as shown in FIG. 25, the grip 304B of the moving member 304 is fitted on the grip 308 of the sample arraying jig body 302, and the rising portion 304C of the moving member 304 is fitted on the lower side of the return 306 of the sample arraying jig body 302. In this state, moreover, between the rising portion 304C of the moving member 304 and one longer side wall portion 302D of the sample arraying jig body 302, there is formed a predetermined clearance 314, the size of which defines a moving stroke of the moving member 304 with respect to the sample arraying jig body 302. Here, the width of the base portion 304A of the moving member 304 is substantially equal to that of the upper face of the bottom wall portion 302A of the sample arraying jig body 302 so that the moving member 304 can slide only in the directions of arrows A of FIG. 25 with respect to the sample arraying jig body 302. In the base portion 304A of the moving member 304, moreover, there are formed a number of second holes 316, which have the same shape and pattern as those of the first holes 312 of the jig body 302. In the (four) peripheral portions of the base portion 304A of the moving member 304 (correspondingly in the (four) peripheral portions of the bottom wall portion 302A of the sample arraying jig body 302, too), there are formed non-hole portions 318 having no hole for giving refuge to the grains 128.

Next, the actions and effects of this embodiment will be described in the following.

In this embodiment, the sample arraying jig 300 is used to place the grains 128 on the upper face (or the sample placing face) of the sample bed 126 of the color scanner 118 in the following manner.

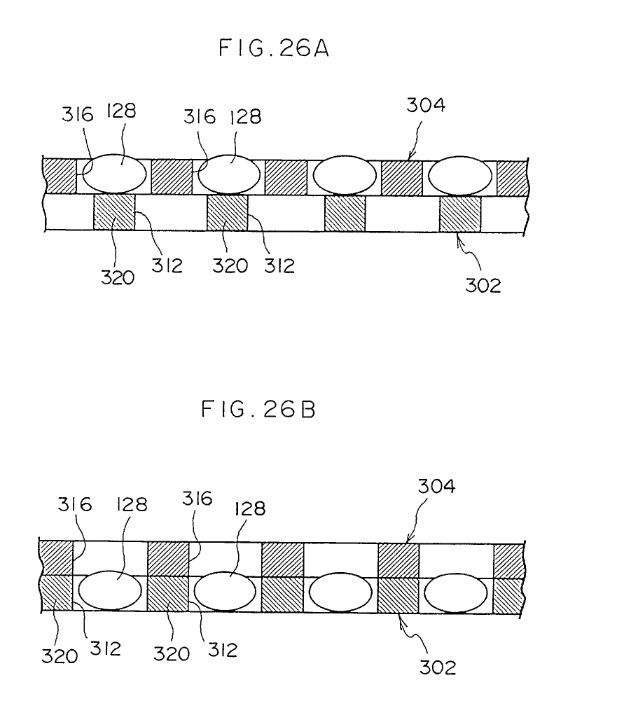

At first, the moving member 304 is fitted in the sample arraying jig body 302 such that the base portion 304A of the moving member 304 is placed on the upper face of the bottom wall portion 302A of the sample arraying jig body 302. Next, the grip 304B is pulled to bring the moving member 304 closer to the grip 308 of the sample arraying jig body 302, as shown in FIG. 25. As a result, the second holes 316 of the moving member 304 and the first holes 312 of the sample arraying jig body 302 are so held that the former holes are offset from the latter holes. As shown in FIG. 26A, portions 320 of the sample arraying jig body 302 which have no first holes provide the bottom face of the second holes (These placing and holding actions belong to a first step). Next, the grains 128 or the samples are put into the sample arraying jig body 302, as indicated by arrow B in FIG. 25. Next, the grains 128 are introduced one by one into the second holes 316 by shaking the sample arraying jig body 302 and the moving member 304 or by raking the grains 128 put in with finger tips or a spatula (These putting-in and introducing actions belong to a second step) Next, the sample arraying jig 300 is inclined to bring the discharge port 310 downward thereby to discharge the excessive grains 128 out of the discharge port 310 of the sample arraying jig body 302. Most of the excessive grains are thus discharged from the discharge port 310, but several to 19 grains 128 may be still left on the upper face of the base portion 304A of the moving member 304. In this case, the remaining grains 128 may be brought to take refuge at the non-hole portions 318 of the moving member 304.

In this state, the sample arraying jig body 302 and the moving member 304 are then placed on the upper face of the sample bed 126 (This placing action belongs to a third step). Next, the moving member 304 is moved so far to the bottom wall portion 302A of the sample arraying jig 300 that the rising portion 304C of the moving member 304 comes to abut against one longer side wall portion 302D of the sample arraying jig body 302, and the second holes 316 are overlaid on the first holes 312. As shown in FIG. 26B, therefore, the second holes 316 and the first holes 312 communicate with each other so that the upper face of the sample bed 126 provides the bottom face of the first holes. Then, the grains 128 having entered the second holes 316 fall down into the first holes 312 so that they are placed on the upper face of the sample bed 126 (These sliding and overlaying actions belong to a fourth step). Next, the sample arraying jig body 302 and the moving member 304 are lifted and removed from the sample bed 126. In the removed state, as shown in FIG. 22, the numerous grains 128 are arrayed at a predetermined interval so that their longer axes are directed to a predetermined direction (These lifting and removing actions belong to a fifth step).

When the sample grains 128 are thus placed on the upper face of the sample bed 126 by using the sample arraying jig 300 according to this embodiment, they can be placed simply and quickly in the arrayed state.

In the sample arraying jig 300 according to this embodiment, moreover, there are formed the discharge port 310 and the non-hole portions 318. Therefore, the excessive grains 128 can be discharged through the discharge port 310 in a short time, and the remaining grains 128, as left after the excessive grains 128 were discharged, can be given refuge to the non-hole portions 318, so that the unnecessary grains 128 can be efficiently eliminated. According to this embodiment, the result is to shorten the working time period for placing the sample grains 128 on the sample bed 126.

The foregoing embodiment has been described on the mode, in which the sample arraying jig 300 is used for the color scanner 118 constructed to include: the scanner body 220 having the sample bed 126 and the scanning unit 130; and the cover member 122 having the light source 140 and the oblique ray louver 142 for functioning as the oblique ray means. However, the sample arraying jig for the grain image reading device according to the invention can also be applied to a color scanner in a mode other than the aforementioned construction. Specifically, the invention may also be applied to the color scanner which has no light source arranged on the side of the cover member 122 (which therefore functions as only a cover for covering the sample bed 126) but which has an essential portion constructed of only the scanner body 120 having the sample bed 126 and the scanning unit 130.

Moreover, in the aforementioned embodiment, the size relation between the two is set such that the moving member 304 can move only in the direction of arrows A in FIG. 25 with respect to the sample arraying jig body 302. However, the invention should not be limited thereto but may be constructed such that the moving member 304 can move in only one direction perpendicular to the directions of arrows A of FIG. 25 (i.e., in the longitudinal direction of the longer side wall portions 302D and 302E of the sample arraying jig body 302) or in both directions with respect to the sample arraying jig body 302.

In the foregoing embodiment, moreover, the non-hole portions 318 are formed in all the peripheral portions of the base portion 304A of the moving member 304 and the bottom wall portion 302A of the sample arraying jig body 302. However, the invention should not be limited thereto but may take a construction in which the non-hole portions are formed in at least one peripheral side of the sample arraying jig body 302 and the moving member 304.

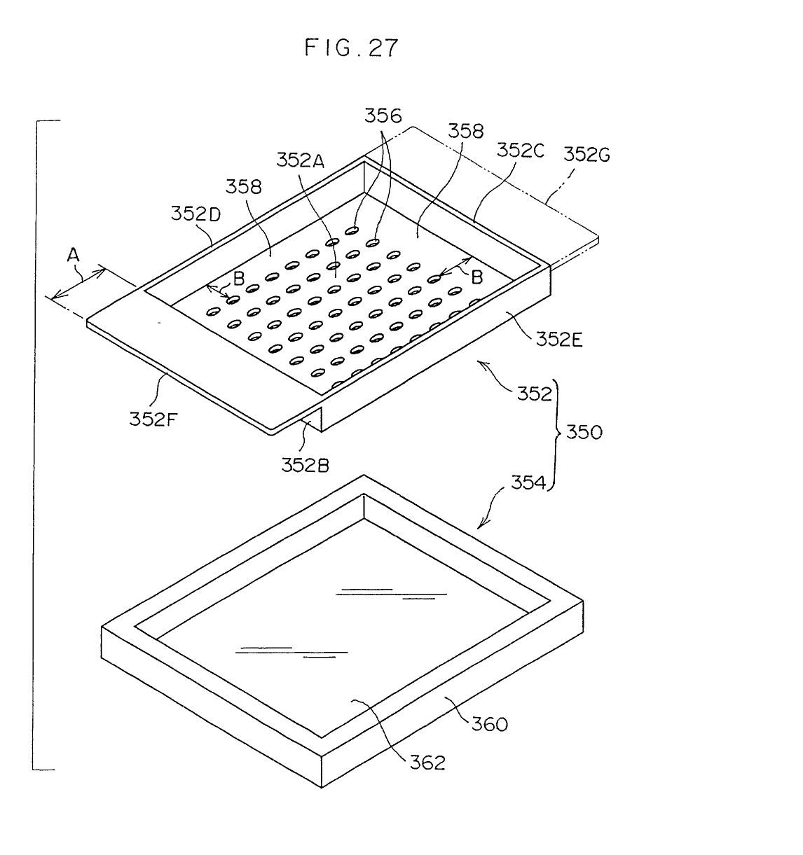

With reference to FIGS. 27 to 29, here will be described an embodiment of a sample arrayer for the grain image reading device according to the invention.

This sample arrayer 350 is provided for placing the grains 128 in an arrayed state on the upper face (or the sample placing face) of the sample bed 126 of the aforementioned color scanner 118 and can be used in the color scanner 118 of the fifth to ninth embodiments.

FIG. 27 is a perspective view of the sample arrayer 350. As shown, the sample arrayer 350 is constructed to include: a sample arraying plate 352 formed generally in a tray shape; and a sample arrayer body 354 for placing the sample arraying plate 352 in a fitting state.

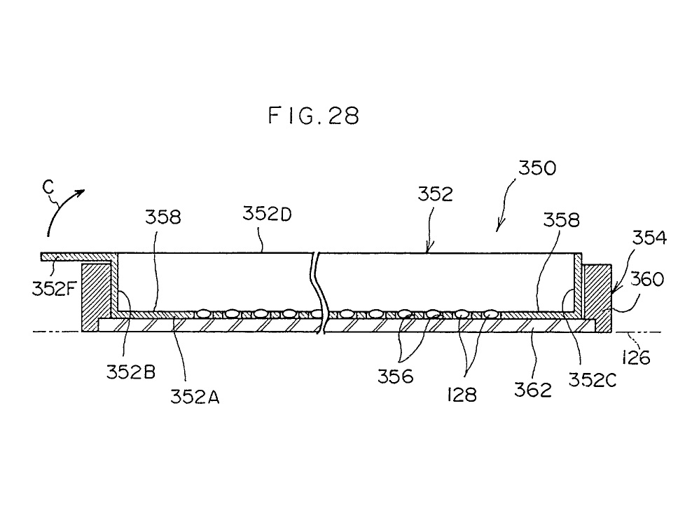

The sample arraying plate 352 is constructed to include: a bottom wall portion 252A having a rectangular shape in a top plan view; side wall portions 352B, 352C, 352D and 352E raised from the peripheral edge portions of the bottom wall portion 352A; and a grip portion 352F extended from one shorter side wall portion 352B. The grip portion 352F has a length A set larger than the thickness of a later-described support member 360 of the sample arrayer body 354 (as also referred to FIG. 28). In the bottom wall portion 352A of the sample arrayer plate 352, moreover, there are formed a number (e.g., 1,000) holes 356. Each hole 356 is formed into such a track shape having a shorter diameter of 3.0 mm to 3.3 mm and a longer diameter of 5.5 mm to 6.0 mm as can accept the grain 128. Moreover, the sample arraying plate 352 has a thickness set to 1.5 mm to 2.0 mm for preventing two sample grains 128 from entering the hole 356. At the (four) peripheral portions of the bottom wall portion 352A of the sample arraying plate 352, moreover, there are formed non-hole portions 358 which have a width B. Here, the sample arraying plate 352 may be made of a metal or a resin.

On the other hand, the sample arrayer body 154 is constructed to include: the support member 360 which is formed into the rectangular frame shape in a top plan view and into which the bottom wall portion 352A of the sample arraying plate 352 can befitted; and a transparentplate362 fixed in a fitted state in the lower end portion of the support member 360. Here, the support member 360 is made of a metal or a resin, and the transparent plate 362 is made of a plate of glass or a resin such as acryl.

With the sample arraying plate 352 being fitted in the sample arrayer body 354, as shown in FIG. 28, the bottom wall portion 352A of the sample arraying plate 352 is placed on the upper face of the transparent plate 362, and the holes 356 formed in the sample arraying plate 352 are closed by the transparent plate 362. With the sample arrayer 350 being placed on the upper face of the sample bed 126, moreover, the transparent plate 362 is placed on the upper face of the sample bed 126.

Next, the actions and effects of this embodiment will be described in the following.

After the aforementioned teaching, the grains 128 are placed in the arrayed state on the sample bed 126 by using the sample arrayer 350. Specifically, the sample arraying plate 352 is fitted in the sample arrayer body 354. In this state, the holes 356 of the sample arraying plate 352 are closed by the transparent plate 362 of the sample arrayer body 354. In this state, a necessary number or more grains 128 are then put onto the sample arraying plate 352. Next, the sample arrayer 350 is shaken vertically and horizontally, or the grains 128 put in are raked with the finger tips or a spatula to introduce the grains 128 one by one into the holes 356. Next, the grip portion 352F is held and lifted to pivot the sample arraying plate 352 in the direction of arrow C of FIG. 28. As a result, the excessive grains 128 are brought to the non-hole portions 358 of the sample arraying plate 352. After this, the sample arraying plate 352 is removed from the sample arrayer body 354 while the grip portion 352F being held. Therefore, the grains 128 are so placed on the upper face of the transparent plate 162 of the sample arrayer body 354 as are arrayed at a predetermined interval in a predetermined direction. At last, the cover member 122 of the color scanner 118 pivots around the hinge 136 and is opened, and the sample arrayer body 354 is placed as it is on the upper face of the sample bed 126.

Next, the reading work of the image of the grains 128 is done after the cover member 122 is closed. This work is done with the sample arrayer body 354 being placed on the upper face of the sample bed 126, as has been described hereinbefore.

Thus, the sample grains 128 are placed on the upper face of the sample bed 126 by using the sample arrayer 350 according to this embodiment, so that the grains 128 can be placed simply and quickly in the arrayed state.

In the sample arrayer 350 according to this embodiment, moreover, the non-hole portions 358 are formed at the peripheral portions of the bottom wall portion 352A of the sample arraying plate 352 so that the excessive grains 128 can be given refuge to the non-hole portions 358. Therefore, the unnecessary grains 128 can be efficiently removed. As a result, it is possible according to this embodiment to shorten the working time period for placing the sample arrayer body 354 on the sample bed 126.

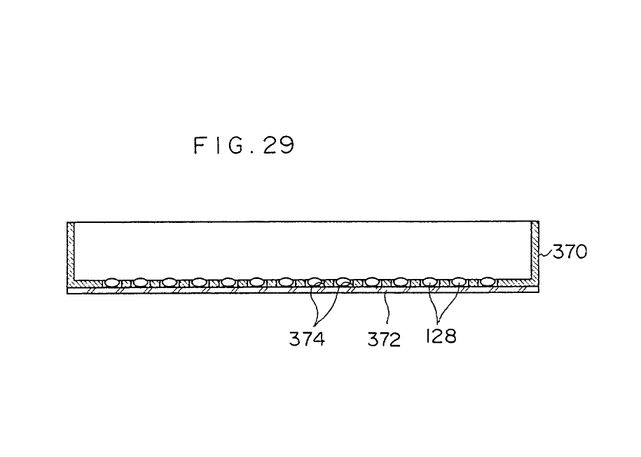

Moreover, the sample arrayer 350 according to this embodiment has the following advantages over the construction shown in FIG. 29. The example shown in FIG. 29 is a modification of the sample arrayer 350 according to this embodiment. Specifically, a transparent plate 372 made of glass or a resin is fixed on the lower end face of a sample arraying plate 370. By adopting this construction, however, dust easily goes (into the clearance) between numerous holes 374 formed in the sample arraying plate 370 and the transparent plate 372 so that it is gradually projected in the image. This construction is disadvantageous because the dust causes errors in the quality judgment of the grains 128. Moreover, it is troublesome to clean the dust at all times. In the case of the sample arrayer 350 according to this embodiment, on the contrary, the sample arraying plate 352 and the sample arrayer body 354 are made separate so that the dust problem can be avoided. According to the sampler arrayer 350 according to this embodiment, therefore, it is possible to improve the quality judgment of the grains 128 and the maintenance.

This embodiment has been described on the mode in which the sample arrayer 350 is used for the color scanner 118 constructed to include: the scanner body 120 having the sample bed 126 and the scanning unit 130; and the cover member 122 having the light source 140 and the oblique ray louver 142 for functioning as the optical ray means. Despite of this description, however, the sample arrayer for the grain image reading unit according to the invention can also be applied to the color scanner in another mode. For example, the invention may also be applied to the color scanner which has no light source arranged on the side of the cover member 122 (which therefore functions as only a cover for covering the sample bed 126) but which has an essential portion constructed of only the scanner body 120 having the sample bed 126 and the scanning unit 130.

In the aforementioned embodiment, moreover, the grip portion 352F is formed on only one side of the sample arraying plate 352. However, the invention should not be limited thereto but may also adopt a construction in which a similar grip portion 352G (as referred to FIG. 27) is formed on the other side. In this modification, the sample arraying plate 352 can be lifted with two hands.

In the foregoing embodiment, moreover, the non-hole portions 358 are formed at all the peripheral portions of the bottom wall portion 352A of the sample arraying plate 352. However, it is sufficient that the non-hole portions 358 are formed at at least one peripheral portion of the bottom wall portions 352A of the sample arraying plate 352.

In the foregoing embodiment, moreover, the support member 360 and the transparent plate 362 are made of the separate parts. If the transparent plate is molded of a resin such as an acrylic plate, however, the support member and the transparent plate may be integrated.

In the foregoing embodiment, moreover, the support member 360 is formed into the rectangular frame shape in a top plan view. However, the support member need not be formed all over the periphery but may be formed at portions of such a predetermined length with respect to the individual sides of the transparent plate as can position the sample arraying plate 352. This construction can sufficiently hold, especially in case the support member and the transparent plate are integrated, as described hereinbefore.

What is claimed is:

1. A grain quality judging sample container comprising:
a sample bed having a transparent bottom face for placing grains thereon;
a light source disposed above said sample bed for emitting a light to illuminate the samples placed on said sample bed; and
an oblique ray louver for homogenizing the light emitted from said light source, in an oblique direction so that the grains placed two-dimensionally on said sample bed may be irradiated with the light in the oblique direction.

2. A grain quality judging sample container comprising:
a sample bed having a transparent bottom face for placing grains thereon; and
a multiplicity of light emitting elements arrayed two-dimensionally to have a light emitting direction inclined with respect to the sample placing face of the sample bed, so that the grains placed two-dimensionally on said sample bed may be irradiated with the light in the oblique direction.

3. A grain quality judging sample container comprising:
a sample bed having a transparent bottom face for placing grains thereon;
a light emitting element array including a multiplicity of light emitting elements arrayed one-dimensionally to have a light emitting direction inclined with respect to the sample placing face of said sample bed, so that the grains placed on said sample bed may be irradiated with the light in the oblique direction; and
moving means for moving at least one of said sample bed and said light emitting element array in a direction to intersect an array direction of said light emitting elements.

4. A grain quality judger comprising:
a grain quality judging sample container according to claim 1;
a scanner for reading images of the grains from a bottom face side of the grain quality judging sample container; and
judging means for judging quality of the grains on the basis of the images of the grains read by said scanner.

5. A grain quality judger comprising:
a grain quality judging sample container according to claim 2;
a scanner for reading images of the grains from a bottom face side of the grain quality judging sample container; and
judging means for judging quality of the grains on the basis of the images of the grains read by said scanner.

6. A grain quality judger comprising:
a grain quality judging sample container according to claim 3;
a scanner for reading images of the grains from a bottom face side of the grain quality judging sample container; and
judging means for judging quality of the grains on the basis of the images of the grains read by said scanner.

7. An image inputting method using a grain quality judger according toclaim4, for extracting both information on a grain inside and information on a grain surface by inter-image operations of a reflected optical image, as read by turning OFF the light in the inclined direction, and an image, as read by turning ON the light in the inclined direction.

8. An image inputting method using a grain quality judger according to claim 5, for extracting both information on a grain inside and information on a grain surface by inter-image operations of a reflected optical image, as read by turning OFF the light in the inclined direction, and an image, as read by turning ON the light in the inclined direction.

9. An image inputting method using a grain quality judger according to claim 6, for extracting both information on a grain inside and information on a grain surface by inter-image operations of a reflected optical image, as read by turning OFF the light in the inclined direction, and an image, as read by turning ON the light in the inclined direction.

10. A grain quality judging system terminal providing a grain quality judger according to claim 4, with functions: to accumulate images and judgment results; to compress data; to encrypt data; to record data in auxiliary storage device media; to print data; to distribute data through a network; and to protect data by a password.

11. A grain quality judging system terminal providing a grain quality judger according to claim 5, with functions: to accumulate images and judgment results; to compress data; to en crypt data; to record data in auxiliary storage device media; to print data; to distribute data through a network; and to protect data by a password.

12. A grain quality judging system terminal providing a grain quality judger according to claim 6, with functions: to accumulate images and judgment results; to compress data; to encrypt data; to record data in auxiliary storage device media; to print data; to distribute data through a network; and to protect data by a password.

13. A grain quality judging system comprising:
a plurality of grain quality judging system terminals connected with a network and according to claim 10; and
administration means connected with said network for displaying the image read by said system terminal and the judgment result of said judging means.

14. A grain quality judging system comprising:
a plurality of grain quality judging system terminals connected with a network and according to claim 11; and
administration means connected with said network for displaying the image read by said system terminal and the judgment result of said judging means.

15. A grain quality judging system comprising:
a plurality of grain quality judging system terminals connected with a network and according to claim 12; and
administration means connected with said network for displaying the image read by said system terminal and the judgment result of said judging means.

16. A grain image reading device comprising:
a scanner body including: a sample bed disposed at an image reading position and having a bottom portion made of a transparent material for placing grains two-dimensionally thereon; and scan means having an optical irradiation portion made movable along the bottom portion of said sample bed for irradiating the grains with a light, and a light receiving portion for receiving a reflected light reflected by the grains; and
a cover member made openable/closable with respect to the sample bed of said scanner body and including oblique ray means for irradiating the grains obliquely when closed,
wherein an image of the grains is read by using two kinds of lights: a transmitted light emitted from said oblique ray means, transmitted through the grains and received by the light receiving portion of said scan means; and a reflected light emitted from said optical irradiation portion, reflected by the grains and received by the light receiving portion of said scan means.

17. A grain image reading device according to claim 16,
wherein said oblique ray means includes: a grain irradiating light source; and an oblique ray louver for regulating an irradiation direction so that the grains may be homogeneously irradiated in an oblique direction with an emitted light emitted from the light source.

18. A grain image reading device according to claim 16,
wherein said oblique ray means includes a plurality of light emitting elements arrayed two-dimensionally and set in a light emitting direction to irradiate the grains in the oblique direction with their lights.

19. A grain image reading device according to claim 16,
wherein said oblique ray means includes a plurality of light emitting elements arrayed one-dimensionally and set in a light emitting direction to irradiate the grains in the oblique direction with their lights, and
wherein at least one of said light emitting elements and said sample bed is moved in a direction to intersect an array direction of said light emitting elements.

20. A grain quality judging device comprising:
a grain image reading device according to claim 16; and
judging means connected with said grain image reading device for judging grain quality on the basis of image information sent from said grain image reading device.

21. A grain quality judging device according to claim 20,
wherein said scan means outputs to said judging means both: image information, which is obtained, with both the light source of said oblique ray means and the optical irradiation portion of said scan means being turned ON, at the time when both the transmitted light emitted from the former light source and transmitted through the grains and the reflected light emitted from the latter and reflected by the grains are simultaneously received by said light receiving portion; and image information, which is obtained, with the light source of said oblique ray means being turned OFF but with said optical irradiation portion being turned ON, at the time when only the reflected light emitted from the latter and reflected by the grains is received by said light receiving portion, and
wherein said judging means determines image information at the time when only the transmitted light is received, by subtracting the image information at the time when only the reflected light is received, from the image information at the time when the transmitted light and the reflected light are simultaneously received, and judges the grain quality.

22. A grain quality judging device according to claim 20,
wherein said scan means outputs to said judging means both: image information, which is obtained, with both the light source of said oblique ray means and the optical irradiation portion of said scan means being turned ON, at the time when both the transmitted light emitted from the former light source and transmitted through the grains and the reflected light emitted from the latter and reflected by the grains are simultaneously received by said light receiving portion; and image information, which is obtained, with the light source of said oblique ray means being turned ON but with said optical irradiation portion being turned OFF, at the time when only the transmitted light emitted from the former and transmitted through the grains is received by said light receiving portion, and
wherein said judging means determines image information at the time when only the reflected light is received, by subtracting the image information at the time when only the transmitted light is received, from the image information at the time when the transmitted light and the reflected light are simultaneously received, and judges the grain quality.

23. A grain quality judging device according to claim 20,
wherein said scan means outputs to said judging means both: image information, which is obtained, with the light source of said oblique ray means being turned ON but with the optical irradiation portion of said scan means being turned OFF, at the time when only the transmitted light emitted from the former light source and transmitted through the grains is received by said light receiving portion; and the image information, which is obtained, with the light source of said oblique ray means being turned OFF but with said optical irradiation portion being turned ON, at the time when only the reflected light emitted from the latter and reflected by the grains is received by said light receiving portion.

24. A grain image reading device comprising:
a scanner body including: a sample bed disposed at an image reading position and having a bottom portion made of a transparent material for placing grains two-dimensionally thereon; and scan means having an optical irradiation portion made movable along the bottom portion of said sample bed for irradiating the grains with a light, and a light receiving portion for receiving a reflected light reflected by the grains; and
a cover member made openable/closable with respect to the sample bed of said scanner body and including a light source for irradiating the grains obliquely when closed,
wherein the optical irradiation portion of said scan means has an optical axis direction set to have a predetermined angle of inclination with respect to the sample placing face of said sample bed, and
wherein said light source is so fixed on the end side of the sample placing face of said sample bed in said cover member as to have an optical axis direction set at a predetermined angle of inclination with respect to the sample placing face of said sample bed.

25. A grain image reading device according to claim 24,
wherein the optical irradiation portion of said scan means and said light source are so constructed as can be turned ON/OFF independently of each other.

26. A sample arraying jig for a grain image reading device having a scanner body including: a sample bed disposed at an image reading position and having a bottom portion made of a transparent material for placing grains two-dimensionally thereon; and scan means having an optical irradiation portion made movable along the bottom portion of said sample bed for irradiating the grains with a light, and a light receiving portion for receiving the reflected light reflected by the grains, comprising:
a sample arraying jig body formed into such a tray shape as can be placed on an upper face of the bottom portion of said sample bed, and including a bottom wall portion having such a multiplicity of holes at a predetermined interval as has a size to admit one grain, as formed generally into a grain shape and as has a longer axis direction in a predetermined direction; and
a moving member formed to such a size as can slide on the upper face of the bottom wall portion of the sample arraying jig body and as can be placed on the upper face of said bottom wall portion, and having a multiplicity of second holes having the same shape and pattern as those of said multiple first holes.

27. A sample arraying jig for a grain image reading device according to claim 26,
wherein said sample arraying jig body has a discharge port at its side wall portion for discharging excessive grains, and a non-hole portion disposed on at least one peripheral portion side of said moving member for giving refuge to the remaining grains.

28. A sample arraying method using a sample arraying jig for a grain image reading device according to claim 27, comprising:
a first step of placing said moving member on the upper face of the bottom wall portion of said sample arraying jig body and holding the two in a state with the second holes being offset from the first holes;
a second step of putting grains as samples in the sample arraying jig body in the state and introducing said grains one by one into the second holes;
a third step of placing said sample arraying jig body and said moving member in the state on the upper face of the bottom portion of the sample bed;
a fourth step of sliding said moving member with respect to the bottom wall portion of said sample arraying jig body and overlaying the second holes on the first holes; and
a fifth step of lifting and removing said sample arraying jig body and said moving member in the state from the sample bed.

29. A sample arrayer for a grain image reading device having a scanner body including: a sample bed disposed at an image reading position and having a bottom portion made of a transparent material for placing grains two-dimensionally thereon; and scan means having an optical irradiation portion made movable along the bottom portion of said sample bed for irradiating the grains with a light, and a light receiving portion for receiving a reflected light reflected by the grains, comprising:
a sample arraying plate formed into a tray shape, and including a bottom wall portion having such a multiplicity of holes at a predetermined interval as has a size to admit one grain, as formed generally into a grain shape and as has a longer axis direction in a predetermined direction; and
a sample arrayer body including: a support member formed generally into such a frame shape as can fit the bottom wall portion of said sample arraying plate; and a transparent plate arranged on the bottom portion of said support member and placed on the upper face of the bottom portion of said sample bed for placing the bottom wall portion of said sample arraying plate.

30. A sample arrayer for a grain image reading device according to claim 29,
wherein said sample arraying plate has a non-hole portion formed on at least one peripheral portion of the bottom wall portion of said sample arraying plate and having none of said holes formed therein.
